(19) United States
(12) Patent Application Publication
(10) Pub. No.: US 2025/0125326 A1
(43) Pub. Date: Apr. 17, 2025

(54) SYSTEMS AND METHODS FOR MANUFACTURING A SEMI-SOLID ELECTRODE FOR USE IN ELECTROCHEMICAL CELLS

(71) Applicant: 24M Technologies, Inc., Cambridge, MA (US)

(72) Inventors: Yuki KUSACHI, Burlington, MA (US); Bradley Richard MILESON, Somerville, MA (US); Naoki OTA, Lexington, MA (US)

(21) Appl. No.: 18/911,725

(22) Filed: Oct. 10, 2024

Related U.S. Application Data
(60) Provisional application No. 63/543,823, filed on Oct. 12, 2023.

(51) Int. Cl. H01M 4/04; H01M 4/02; H01M 50/406; H01M 50/46

(52) U.S. Cl. CPC H01M 4/0404; H01M 4/0433; H01M 50/406; H01M 50/46; H01M 2004/025; H01M 2004/027; H01M 2004/028

(57) ABSTRACT

Embodiments described herein relate to electrochemical cells that include electrodes having two-dimensional surface patterns. In some aspects, the electrochemical cell can include a cathode current collector, an anode current collector, a cathode material disposed on the cathode current collector, an anode material disposed on the anode current collector, and a separator interposed between the cathode material and the anode material. The cathode material includes a first cathode surface abutting the cathode current collector and having a first cathode surface profile that is substantially flat and planar. The cathode material further includes a second cathode surface opposite to the first cathode surface and having a second cathode surface profile comprising a plurality of projections extending in a direction away from the first cathode surface. The anode material includes a first anode surface abutting the anode current collector and having a first anode surface profile that is substantially flat and planar.

### CROSS-REFERENCE TO RELATED APPLICATIONS

The present application claims priority to and the benefit of U.S. Provisional Application No. 63/543,823, filed Oct. 12, 2023, and entitled “Systems and Methods for Manufacturing a Semi-Solid Electrode for Use in Electrochemical Cells,” the entire disclosure of which is incorporated herein by reference.

### TECHNICAL FIELD

Embodiments described herein relate to electrochemical cells formulated to increase power capacity.

### BACKGROUND

Lithium-ion batteries are manufactured with a combination of flat electrodes. Batteries and electrochemical cells with three-dimensional electrode structures have been proposed for the purpose of increasing power capability. However, it is difficult to manufacture three-dimensional electrodes cheaply and efficiently due to the complicated manufacturing technologies currently available.

### SUMMARY

Embodiments described herein relate to electrochemical cells that include electrodes having two-dimensional surface patterns. In some aspects, the electrochemical cell can include a cathode current collector, an anode current collector, a cathode material disposed on the cathode current collector, an anode material disposed on the anode current collector, and a separator interposed between the cathode material and the anode material. The cathode material includes a first cathode surface abutting the cathode current collector and having a first cathode surface profile that is substantially flat and planar. The cathode material further includes a second cathode surface opposite the first cathode surface and having a second cathode surface profile comprising a plurality of projections extending in a direction away from the first cathode surface. The anode material includes a first anode surface abutting the anode current collector and having a first anode surface profile that is substantially flat and planar. The anode material also includes a second anode surface opposite to the first anode surface and having a second anode profile complementary to the second cathode surface profile.

In some embodiments, an electrode includes: a current collector; a semi-solid electrode material disposed on the current collector, the semi-solid electrode having: a first surface abutting the current collector and having a first surface profile that is substantially flat and planar; and a second surface opposite to the first surface and having a second surface profile including a plurality of projections extending in a direction away from the first surface; and a separator coupled to the semi-solid electrode and covering an entirely of the second surface.

In some embodiments, an electrochemical cell includes: a cathode current collector; an anode current collector; a cathode material disposed on the cathode current collector, the cathode material including: a first cathode surface abutting the cathode current collector and having a first cathode surface profile that is substantially flat and planar; and a second cathode surface opposite to the first cathode surface and having a second cathode surface profile comprising a plurality of projections extending in a direction away from the first cathode surface; an anode material disposed on the anode current collector, the anode material including: a first anode surface abutting the anode current collector and having a first anode surface profile that is substantially flat and planar; and a second anode surface opposite the first anode surface and having a second anode profile complementary to the second cathode surface profile such that the second anode surface and the second cathode surface mesh together; and a separator interposed between the anode material and the cathode material.

In some embodiments, a method of forming an electrochemical cell includes: disposing a first electrode material on a first current collector; positioning a separator on the first electrode material; impressing the first electrode material to form a first electrode pattern; casting a second electrode material with the first electrode material to form a second electrode pattern on the second electrode material, the second electrode pattern being complementary to the first electrode pattern; and applying a second current collector to the second electrode material.

### BRIEF DESCRIPTION OF THE DRAWINGS

FIG. 1 is a block diagram of an electrochemical cell, according to an embodiment.

FIG. 2 is an illustration of a cross-section of an electrochemical cell including electrodes having two-dimensional patterns, according to an embodiment.

FIG. 3 is an illustration of an electrode having a two-dimensional pattern, according to an embodiment.

FIG. 4 is an illustration of an electrode having a three-dimensional pattern, according to an embodiment.

FIG. 5 is an illustration of a cross-section of an electrochemical cell including electrodes having two-dimensional patterns, according to an embodiment.

FIG. 6 is an illustration of a cross-section of an electrochemical cell including electrodes having two-dimensional patterns, according to an embodiment.

FIG. 7 is a block diagram of a method of manufacturing the electrochemical cell of at least one of FIGS. 1, 2, 5, and 6, according to an embodiment.

FIG. 8 is an illustration of the method of manufacturing of FIG. 7, according to an embodiment.

FIG. 9 is a block diagram of a method of manufacturing the electrochemical cell of at least one of FIGS. 1, 2, 5, and 6, according to an embodiment.

FIG. 10 is an illustration of the method of manufacturing of FIG. 9, according to an embodiment.

FIG. 11 is a block diagram of a method of manufacturing the electrochemical cell of at least one of FIGS. 1, 2, 5, and 6, according to an embodiment.

FIG. 12 is an illustration of the method of manufacturing of FIG. 11, according to an embodiment.

FIG. 13 is a block diagram of a method of manufacturing the electrochemical cell of at least one of FIGS. 1, 2, 5, and 6, according to an embodiment.

FIG. 14 is an illustration of the method of manufacturing of FIG. 13, according to an embodiment.

FIG. 15 is a block diagram of a method of manufacturing the electrochemical cell of at least one of FIGS. 1, 2, 5, and 6, according to an embodiment.

FIG. 16 is an illustration of the method of manufacturing of FIG. 15, according to an embodiment.

FIGS. 17-20 are illustrations of the method of manufacturing of FIG. 8, according to an embodiment.

FIG. 21 is a plot comparing the energy capacity of two electrochemical cells after a first charge cycle and a first discharge cycle.

FIG. 22 is a plot comparing the energy capacity of two electrochemical cells after a third charge cycle and a third discharge cycle.

FIG. 23 is an illustration of a particle surface lithium concentration for an electrochemical cell, according to an embodiment.

FIG. 24 is an illustration of a particle surface lithium concentration for an electrochemical cell, according to an embodiment.

FIG. 25 is a plot of a simulated area specific capacity of the electrochemical cells of FIGS. 23 and 24 during various charge and discharge cycles.

FIG. 26 is an illustration of various electrochemical cells, according to an embodiment.

FIG. 27 is a plot of a simulated full cell charge voltage profile of the electrochemical cells of FIG. 26 having various two-dimensional wave pitches.

### DETAILED DESCRIPTION

Embodiments described herein relate generally to methods for forming a semi-solid electrode material having a two-dimensional surface pattern and methods for forming an electrochemical cell including the same. In some embodiments, the semi-solid electrode can be formed by mechanically deforming (e.g., compressing, rolling, imprinting, embossing) a semi-solid electrode material disposed on a current collector. In some embodiments, mechanically compressing includes compressing the semi-solid electrode material between a die and a base.

Conventional electrode materials are typically manufactured by coating a metallic substrate (e.g., a current collector) with an electrode slurry composed of an active material, a conductive additive, and a binding agent dissolved or dispersed in a solvent or water, evaporating the solvent or water, and calendering the dried solid matrix to a specified thickness. The electrodes are then cut, packaged with other components, infiltrated with electrolyte and the entire package is then sealed. Such methods generally involve complicated and expensive manufacturing steps such as casting the electrode. These methods for producing electrodes result in batteries with lower capacity, lower energy density and a high ratio of inactive components to active materials. Furthermore, the binders used in known electrode formulations can increase tortuosity and decrease the ionic conductivity of the electrode. In some embodiments, electrodes described herein can be free or substantially free of binder.

Since the electrolyte is infused after calendering conventional electrode materials, it typically involves a significant amount of effort to infuse the electrolyte after forming the electrochemical cell. Conventional methods for infusing the calendered electrode materials with the liquid electrolyte include the use of high pressure or a long infusion time to achieve adequate permeation of the liquid electrolyte into the electrode material. Typically, conventional electrodes are calendered to only about 20% porosity to facilitate the infusion of electrolyte into the calendered electrode material. Therefore, a trade-off exists between energy density of the finished electrode and the degree of densification of the electrode material. In other words, since conventional electrode materials after calendering are typically denser, it can be more difficult to permeate with the liquid electrolyte. Therefore, conventional electrode materials are often not fully wetted by electrolyte after infusion, which means that the realized energy density can be substantially lower than the theoretical energy density.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in U.S. Patent Publication No. 2022/0238923 (“the '923 publication”), filed Jan. 21, 2022 and titled “Production of Semi-Solid Electrodes Via Addition of Electrolyte to Mixture of Active Material, Conductive Material, and Electrolyte Solvent,” and Provisional Patent Application No. 63/354,056 (“the '056 application”), filed Jun. 21, 2022 and titled “Electrochemical Cells with High-Viscosity Semi-solid Electrodes, and Methods of Making the Same,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

The semi-solid electrodes described herein are formulated as a mixture of solid phases and liquid phases such that the electrolyte is included in the slurry formulation. This is in contrast to conventional electrodes, for example calendered electrodes, where the electrolyte is generally added to the electrochemical cell once the electrochemical cell has been disposed in a container, for example, a pouch or a can. Exposure of the semi-solid electrodes to the ambient environments for longer periods of time can increase evaporation of the electrolyte, thereby affecting physical characteristics (e.g., flowability) and/or electronic characteristics (e.g., conductivity, charge capacity, energy density, etc.) of the electrochemical cell. Moreover, moisture in the ambient environment can also detrimentally affect the performance of the electrolyte. Thus, it would be of benefit to assemble the electrochemical cell that includes the semi-solid electrodes described herein, in the shortest amount of time to limit electrolyte evaporation and/or degradation. In some instances, however, disposing the semi-solid electrodes on both sides of a current collector (e.g., a metal foil) can take a substantial amount of time. Moreover, to form an electrochemical cell stack from such electrochemical cells, a spacer is often disposed between adjacent electrochemical cells, which can further increase the time that the semi-solid electrodes included in the electrochemical cells are exposed to the ambient atmosphere.

Embodiments of electrochemical cells described herein include semi-solid electrodes that are coated on only one side of current collectors and include a two-dimensional (2D) contact area between the anode and the separator and/or the cathode and the separator. Coating only one side of the current collectors reduces the manufacturing complexity as well as the time associated with coating both sides of the current collectors. An electrochemical cell stack can then easily be formed by stacking the electrochemical cells such that the current collectors of adjacent electrochemical cells abut each other. For example, an uncoated side of a positive current collector included in a first electrochemical cell can abut an uncoated side of a positive current collector included in a second electrochemical cell. Similarly, an uncoated side of a negative current collector included in the first electrochemical cell can abut an uncoated side of a negative current collector included in a third electrochemical cell, and so on. This can further reduce the amount of time used for forming the electrochemical cell stack, thereby minimizing exposure of the electrodes to ambient environment. The short assembly time required to form the electrochemical cell also reduce electrolyte evaporation and or degradation of the semi-solid electrodes due to water permeation can also be minimized.

In some embodiments, a semi-solid electrode having a two-dimensional patterned surface includes a semi-solid electrode material disposed on a current collector. The semi-solid electrode material has a first surface abutting the current collector and a second surface opposite the first surface. The second surface of the semi-solid electrode has a two-dimensional surface pattern. Thus, the second surface of the semi-solid electrode has a greater surface area than the first surface of the semi-solid electrode. In some embodiments, the semi-solid electrode includes a three-dimensional patterned surface.

In some embodiments, an electrochemical cell includes a cathode material disposed on a cathode current collector and an anode material disposed on an anode current collector. A surface of the cathode material opposite to the cathode current collector includes a two-dimensional cathode surface pattern. A surface of the anode material opposite to the anode current collector includes a two-dimensional anode surface pattern complementary to the cathode surface pattern. The electrochemical cell further includes a separator interposed between the cathode material and the anode material and conforming to both the cathode surface pattern and the anode surface pattern. The cathode material and the anode material mesh together with the separator disposed therebetween.

In some embodiments, the method of manufacturing an electrochemical cell having semi-solid electrodes, each having a two-dimensional surface pattern, includes mixing an active material and a conductive material with a liquid electrolyte to form a first semi-solid electrode material and disposing the first semi-solid electrode material onto a current collector. The method can further include disposing a separator onto an exposed surface of the first semi-solid electrode material and impressing the first semi-solid electrode material with an impression device to form a first two-dimensional pattern on a surface of the first semi-solid electrode material. In some embodiments, the step of impressing the first semi-solid electrode material includes extracting a portion of the liquid electrolyte from the first semi-solid electrode material. In some embodiments, the first semi-solid electrode can be deformed, compressed, and/or embossed using a mechanical press. In some embodiments, the separator can absorb a portion of the liquid electrolyte extracted during impressing. In some embodiments, impressing the first semi-solid electrode material includes compressing the first semi-solid electrode material between a die and a base. The method of manufacturing the electrochemical cell further includes casting a second semi-solid electrode with the first semi-solid electrode material to form a second two-dimensional pattern on a surface of the second semi-solid electrode material, the second two-dimensional pattern being complementary to the first two-dimensional pattern such that the first semi-solid electrode material and the second semi-solid electrode material mesh together with the separator disposed therebetween. The method further includes disposing a second current collector on the second semi-solid electrode material, thus forming the electrochemical cell having semi-solid electrodes, each of the electrodes having a two-dimensional surface pattern.

In some embodiments, the method of manufacturing an electrochemical cell having semi-solid electrodes, each having a two-dimensional surface pattern, includes mixing an active material and a conductive material with a liquid electrolyte to form a first semi-solid electrode material and disposing the first semi-solid electrode material onto a current collector. The method further includes impressing the first semi-solid electrode material with an impression device to form a first two-dimensional pattern on a surface of the first semi-solid electrode material. In some embodiments, the step of impressing the first semi-solid electrode material includes extracting a portion of the liquid electrolyte from the first semi-solid electrode material. In some embodiments, the first semi-solid electrode can be deformed, compressed, and/or embossed using a mechanical press. In some embodiments, impressing the first semi-solid electrode material includes compressing the first semi-solid electrode material between a die and a base. The method can further include disposing a separator onto the first patterned surface of the first semi-solid electrode and conforming the separator to the first patterned surface. The method of manufacturing the electrochemical cell further includes casting a second semi-solid electrode with the first semi-solid electrode material to form a second two-dimensional pattern on a surface of the second semi-solid electrode material, the second two-dimensional pattern being complementary to the first two-dimensional pattern such that the first semi-solid electrode material and the second semi-solid electrode material mesh together with the separator disposed therebetween. The method further includes disposing a second current collector on the second semi-solid electrode material, thus forming the electrochemical cell having semi-solid electrodes, each of the electrodes having a two-dimensional surface pattern.

In some embodiments, the method of manufacturing an electrochemical cell having semi-solid electrodes, each having a two-dimensional surface pattern, includes mixing an active material and a conductive material with a liquid electrolyte to form a first semi-solid electrode material and disposing the first semi-solid electrode material onto a current collector. The method can further include disposing a separator onto an exposed surface of the first semi-solid electrode material and impressing the first semi-solid electrode material with an impression device to form a first two-dimensional pattern on a surface of the first semi-solid electrode material. In some embodiments, the step of impressing the first semi-solid electrode material includes extracting a portion of the liquid electrolyte from the first semi-solid electrode material. In some embodiments, the first semi-solid electrode can be deformed, compressed, and/or embossed using a mechanical press. In some embodiments, the separator can be configured to absorb a portion of the liquid electrolyte extracted during impressing. In some embodiments, impressing the first semi-solid electrode material includes compressing the first semi-solid electrode material between a die and a base.

The method can further include mixing an active material and a conductive material with a liquid electrolyte to form a second semi-solid electrode material and disposing the second semi-solid electrode material onto a second current collector.

The method of manufacturing the electrochemical cell further includes casting the second semi-solid electrode with the first semi-solid electrode material to form a second two-dimensional pattern on a surface of the second semi-solid electrode material, the second two-dimensional pattern being complementary to the first two-dimensional pattern such that the first semi-solid electrode material and the second semi-solid electrode material mesh together with the separator disposed therebetween. The step of casting can include positioning the first semi-solid electrode and the second semi-solid electrode into a vacuum pouch, removing the air from the vacuum pouch, and casting the second semi-solid electrode material with the atmospheric pressure applied to the vacuum pouch, thus forming the electrochemical cell having semi-solid electrodes, each of the electrodes having a two-dimensional surface pattern.

In some embodiments, the method of manufacturing an electrochemical cell having semi-solid electrodes, each having a two-dimensional surface pattern, includes mixing an active material and a conductive material with a liquid electrolyte to form a first semi-solid electrode material and disposing the first semi-solid electrode material into a mold, the mold impressing a first two-dimensional pattern into the first semi-solid electrode material. The method can further include demolding the first semi-solid electrode material and disposing the first semi-solid electrode material on a first current collector. The method can further include disposing a separator onto the first patterned surface of the first semi-solid electrode and conforming the separator to the first patterned surface.

The method of manufacturing the electrochemical cell further includes casting a second semi-solid electrode with the first semi-solid electrode material to form a second two-dimensional pattern on a surface of the second semi-solid electrode material, the second two-dimensional pattern being complementary to the first two-dimensional pattern such that the first semi-solid electrode material and the second semi-solid electrode material mesh together with the separator disposed therebetween. The method further includes disposing a second current collector on the second semi-solid electrode material, thus forming the electrochemical cell having semi-solid electrodes, each of the electrodes having a two-dimensional surface pattern.

In some embodiments, the method of manufacturing an electrochemical cell having semi-solid electrodes, each having a two-dimensional surface pattern, includes positioning a separator into a mold, the mold configured to impress a first pattern into a semi-solid material. The method further includes mixing an active material and a conductive material with a liquid electrolyte to form a first semi-solid electrode material and disposing the first semi-solid electrode material into the mold having the separator, the mold impressing a first two-dimensional pattern into the first semi-solid electrode material. The method can further include demolding the first semi-solid electrode material and disposing the first semi-solid electrode material on a first current collector. The method can further include disposing a separator onto the first patterned surface of the first semi-solid electrode and conforming the separator to the first patterned surface.

The method of manufacturing the electrochemical cell further includes casting a second semi-solid electrode with the first semi-solid electrode material to form a second two-dimensional pattern on a surface of the second semi-solid electrode material, the second two-dimensional pattern being complementary to the first two-dimensional pattern such that the first semi-solid electrode material and the second semi-solid electrode material mesh together with the separator disposed therebetween. The method further includes disposing a second current collector on the second semi-solid electrode material, thus forming the electrochemical cell having semi-solid electrodes, each of the electrodes having a two-dimensional surface pattern.

The mixing and forming of a semi-solid electrode can include: (i) raw material conveyance and/or feeding, (ii) mixing, (iii) mixed slurry conveyance, (iv) dispensing and/or extruding, and (v) forming. In some embodiments, multiple steps in the process can be performed at the same time and/or with the same piece of equipment. For example, the mixing and conveyance of the slurry can be performed at the same time with an extruder. Each step in the process can include one or more possible embodiments. For example, each step in the process can be performed manually or by any of a variety of process equipment. Each step can also include one or more sub-processes and, optionally, an inspection step to monitor process quality.

In some embodiments, the process conditions can be selected to produce a prepared slurry having a mixing index of at least about 0.80, at least about 0.90, at least about 0.95, or at least about 0.975. In some embodiments, the process conditions can be selected to produce a prepared slurry having an electronic conductivity of at least about 10⁻⁶ S/cm, at least about 10⁻⁵ S/cm, at least about 10⁻⁴ S/cm, at least about 10⁻³ S/cm, or at least about 10⁻² S/cm. In some embodiments, the process conditions can be selected to produce a prepared slurry having an apparent viscosity at room temperature of less than about 100,000 Pa-s, less than about 10,000 Pa-s, or less than about 1,000 Pa-s, all at an apparent shear rate of 1,000 s⁻¹. In some embodiments, the process conditions can be selected to produce a prepared slurry having two or more properties as described herein. Examples of systems and methods that can be used for preparing the semi-solid electrode compositions described herein are described in U.S. Patent publication No. 2013/0337319 (also referred to as “the '319 publication”), filed Mar. 15, 2013, entitled “Electrochemical Slurry Compositions and Methods for Preparing the Same,” the entire disclosure of which is hereby incorporated by reference.

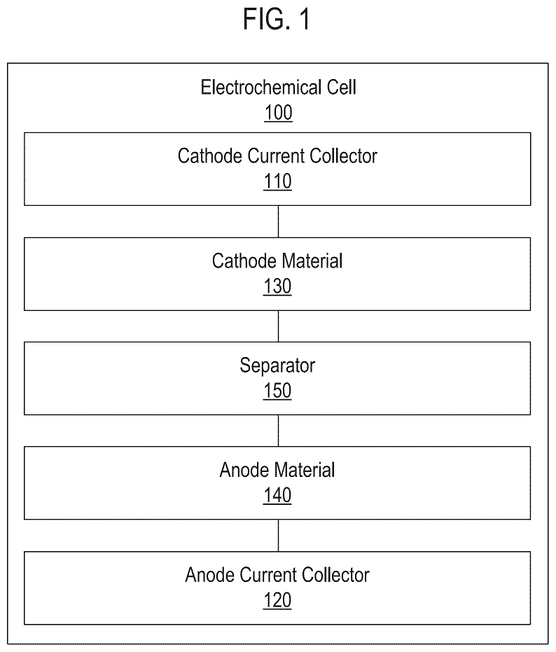

FIG. 1 shows a schematic illustration of an electrochemical cell 100. The electrochemical cell 100 includes a positive current collector, shown as a cathode current collector 110, and a negative current collector, shown as an anode current collector 120. A cathode material 130 is disposed on (e.g., coupled to) the cathode current collector 110. The cathode material 130 may be semi-solid (e.g., may be a semi-solid). An anode material 140 is disposed on the anode current collector 120. The anode material 140 may be semi-solid. In some implementations, at least one of the cathode material 130 and the anode material 140 has a thickness of at least about 100 μm (micrometers), for example, in the range of about 100 μm to about 2,000 μm.

The cathode current collector 110 and the anode current collector 120 can be any current collectors that are electronically conductive and are electrochemically inactive under the operating conditions of the electrochemical cell 100. In some embodiments, the anode current collector 120 can include copper, aluminum, and/or or titanium. In some embodiments, the cathode current collector 110 can include aluminum. In some embodiments, the anode current collector 120 and/or the cathode current collector 110 can be in the form of sheets or mesh, or any combination thereof. Current collector materials can be selected to be stable at the operating potentials of the cathode material 130 and the anode material 140 of the electrochemical cell 100. For example, in non-aqueous lithium systems, the cathode current collector 110 can include aluminum, or aluminum coated with conductive material that does not electrochemically dissolve at operating potentials of 2.5-5.0V with respect to Li/Li⁺. Such materials include platinum, gold, nickel, conductive metal oxides such as vanadium oxide, and carbon. The anode current collector 120 can include copper or other metals that do not form alloys or intermetallic compounds with lithium, carbon, and/or coatings comprising such materials disposed on another conductor. Each of the cathode current collector 110 and the anode current collector 120 can have a thickness of less than about 20 microns (e.g., μm, micrometers), for example, about 1 micron, about 2 microns, about 3 microns, about 4 microns, about 5 microns, about 6 microns, about 7 microns, about 8 microns, about 9 microns, about 10 microns, about 12 microns, about 14 microns, about 16 microns, or about 18 microns, inclusive of all ranges therebetween. Use of thin current collectors can substantially reduce the cost and overall weight of the electrochemical cell 100.

The electrochemical cell 100 further includes a separator 150 interposed between the cathode material 130 and the anode material 140. The separator 150 separates the cathode material 130 and the anode material 140 such that the cathode material 130 does not contact or engage with the anode material 140. The separator 150 can be any conventional membrane that is capable of ion transport, such as an ion-permeable membrane. In some embodiments, the separator 150 is a liquid impermeable membrane that permits the transport of ions therethrough, namely a solid or gel ionic conductor. In some embodiments, the separator 150 is elastically deformable such that the separator can elastically and plastically deform while still preventing the cathode material 130 and the anode material 140 from contacting one another. In some embodiments, the separator 150 is flexible and inelastic such that the separator can be bent without stretching in length (e.g., elongating). For example, the separator 150 may be crimped or corrugated without changing or affecting a porosity or density of the separator 150. In some embodiments the separator 150 is a porous polymer membrane infused with a liquid electrolyte that allows for the shuttling of ions between the cathode material 130 and the anode material 140 while preventing the transfer of electrons. In some embodiments, the separator 150 is a microporous membrane that prevents particles forming the cathode material 130 and the anode material 140 from crossing the membrane. In some embodiments, the separator 150 is a single or multilayer microporous separator, optionally with the ability to fuse or “shut down” above a certain temperature so that it no longer transmits working ions, of the type used in the lithium-ion battery industry and well-known to those skilled in the art. In some embodiments, the separator 150 can include a polyethyleneoxide (PEO) polymer in which a lithium salt is complexed to provide lithium conductivity, or Nafion™ membranes which are proton conductors. For example, PEO based electrolytes can be used as the separator 150, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes, which can be especially useful in phosphate-based cell chemistries with cell potential at the positive electrode that is less than about 3.6 V with respect to Li metal. The operating temperature of the redox cell can be elevated as necessary to improve the ionic conductivity of the membrane.

The cathode material 130 can include an ion-storing solid phase material which can include, for example, an active material and/or a conductive material. The quantity of the ion-storing solid phase material can be in the range of about 0% to about 80% by volume. The cathode material 140 can include an active material such as, for example, a lithium bearing compound (e.g., Lithium Iron Phosphate (LFP), LiCoO₂, LiCoO₂ doped with Mg, LiNiO₂, Li(Ni, Co, Al)O₂ (known as “NCA”), Li(Ni, Mn, Co)O₂ (known as “NMC”), LiMn₂O₄ and its derivatives, etc.). The cathode material 140 can also include a conductive material such as, for example, graphite, carbon powder, pyrolytic carbon, carbon black, carbon fibers, carbon microfibers, carbon nanotubes (CNTs), single walled CNTs, multi walled CNTs, fullerene carbons including “bucky balls,” graphene sheets and/or aggregate of graphene sheets, any other conductive material, alloys or combination thereof. The cathode material 130 can also include a non-aqueous liquid electrolyte such as, for example, ethylene carbonate, dimethyl carbonate, diethyl carbonate, SSDE, and/or any other electrolyte described herein or combination thereof.

In some embodiments, the anode material 140 can also include an ion-storing solid phase material which can include, for example, an active material and/or a conductive material. The quantity of the ion-storing solid phase material can be in the range of about 0% to about 80% by volume. The anode material 140 can include an anode active material such as, for example, lithium metal, carbon, lithium-intercalated carbon, lithium nitrides, lithium alloys and lithium alloy forming compounds of silicon, bismuth, boron, gallium, indium, zinc, tin, tin oxide, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other materials or alloys thereof, and any other combination thereof.

The anode material 140 can also include a conductive material which can be a carbonaceous material such as, for example, graphite, carbon powder, pyrolytic carbon, carbon black, carbon fibers, carbon microfibers, carbon nanotubes (CNTs), single walled CNTs, multi walled CNTs, fullerene carbons including “bucky balls”, graphene sheets and/or aggregate of graphene sheets, any other carbonaceous material or combination thereof. In some embodiments, the anode material 140 can also include a non-aqueous liquid electrolyte such as, for example, ethylene carbonate, dimethyl carbonate, diethyl carbonate, or any other electrolyte described herein or combination thereof.

In some embodiments, the cathode material 130 and the anode material 140 can include active materials and optionally conductive materials in particulate form suspended in a non-aqueous liquid electrolyte. In some embodiments, the particles forming the cathode material 130 and the anode material 140 (e.g., cathodic or anodic particles) can have an effective diameter of at least about 1 μm (e.g., microns). In some embodiments, the cathodic or anodic particles have an effective diameter between about 1 μm and about 10 μm. In some embodiments, the cathodic or anodic particles have an effective diameter of at least about 10 μm or more. In some embodiments, the cathodic or anodic particles have an effective diameter of less than about 1 μm. In some embodiments, the cathodic or anodic particles have an effective diameter of less than about 0.5 μm. In some embodiments, the cathodic or anodic particles have an effective diameter of less than about 0.25 μm. In some embodiments, the cathodic or anodic particles have an effective diameter of less than about 0.1 μm. In some embodiments, the cathodic or anodic particles have an effective diameter of less than about 0.05 μm. In other embodiments, the cathodic or anodic particles have an effective diameter of less than about 0.01 μm.

In some embodiments, the cathode material 130 can include about 20% to about 80% by volume of an active material. In some embodiments, the anode material 140 can include about 40% to about 75% by volume, about 50% to about 75% by volume, about 60% to about 75% by volume, or about 60% to about 80% by volume of an active material.

In some embodiments, the cathode material 130 can include about 0% to about 25% by volume of a conductive material. In some embodiments, the cathode material 130 can include about 1.0% to about 6% by volume, about 6% to about 12%, or about 2% to about 15% by volume of a conductive material.

In some embodiments, the cathode material 130 can include about 20% to about 70% by volume of an electrolyte. In some embodiments, the cathode material 130 can include about 30% to about 60%, about 40% to about 50%, or about 20% to about 40% by volume of an electrolyte.

In some embodiments, the anode material 140 can include about 20% to about 80% by volume of an active material. In some embodiments, the anode material 150 can include about 40% to about 75% by volume, about 50% to about 75%, about 60% to about 75%, or about 60% to about 80% by volume of an active material.

In some embodiments, the anode material 140 can include about 0% to about 20% by volume of a conductive material. In some embodiments, the anode material 140 can include about 1% to about 10% by volume, about 1% to about 6% by volume, about 0.5% to about 2% by volume, about 2% to about 6% by volume, or about 2% to about 4% by volume of a conductive material.

In some embodiments, the anode material 140 can include about 20% to about 70% by volume of an electrolyte. In some embodiments, the anode material 140 can include about 30% to about 60% by volume, about 40% to about 50% by volume, or about 20% to about 40% by volume of an electrolyte.

Examples of active materials, conductive materials, and/or electrolytes that can be used in the compositions of the cathode material 130 and the anode material 140, various formulations thereof, and electrochemical cells formed therefrom, are described in the '159 patent, U.S. Pat. No. 8,722,226 (also referred to as “the '226 patent”), issued May 13, 2014, entitled “High Energy Density Redox Flow Device,” and U.S. Pat. No. 9,786,944 (also referred to as “the '944 patent”), filed Dec. 16, 2010, entitled “High Energy Density Redox Flow Device,” the entire disclosures of which are hereby incorporated by reference.

In some embodiments, the anode material 140 can also include about 1% to about 30% by volume of a high-capacity material. Such high-capacity materials can include, for example, silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high-capacity materials or alloys thereof, and any combination thereof. In some embodiments, the anode material 140 can include about 1% to about 5% by volume, about 1% to about 10% by volume, or about 1% to about 20% by volume of the high-capacity material.

While described herein as including cathode material 130 and anode material 140, in some embodiments, the electrochemical cell 100 can include only one semi-solid electrode. For example, in some embodiments, the cathode material 130 can be a semi-solid cathode and the anode material 140 can be a conventional solid anode (e.g., a high-capacity solid anode). Similarly, in some embodiments, the cathode material 130 can be solid and the anode material 140 can be semi-solid.

In some embodiments, the electrolyte included in the at least one of the cathode material 130 and the anode material 140 can include about 0.1% to about 1% by weight of a gel-polymer additive.

In some embodiments, the semi-solid suspensions of the cathode material 130 and the anode material 140 can initially be flowable and can be caused to become non-flowable by “fixing.” In some embodiments, fixing can be performed by the action of photopolymerization. In some embodiments, fixing is performed by action of electromagnetic radiation with wavelengths that are transmitted by the unfilled positive and/or negative electroactive zones of the electrochemical cell 100 formed from a semi-solid cathode and/or semi-solid anode. In some embodiments, the semi-solid suspension can be fixed by heating. In some embodiments, one or more additives are added to the semi-solid suspensions to facilitate fixing.

In some embodiments, the injectable and flowable cathode material 130 and anode material 140 is caused to become non-flowable by “plasticizing.” In some embodiments, the rheological properties of the injectable and flowable semi-solid suspension are modified by the addition of a thinner, a thickener, and/or a plasticizing agent. In some embodiments, these agents promote processability and help retain compositional uniformity of the semi-solid suspension under flowing conditions and positive and negative electroactive zone filling operations. In some embodiments, one or more additives are added to the flowable semi-solid suspension to adjust its flow properties to accommodate processing requirements.

Systems employing negative and/or positive ion-storage materials that are storage hosts for working ions, meaning that said materials can take up or release the working ion while all other constituents of the materials remain substantially insoluble in the electrolyte, are particularly advantageous as the electrolyte does not become contaminated with electrochemical composition products. In addition, systems employing negative and/or positive lithium ion-storage materials are particularly advantageous when using non-aqueous electrochemical compositions.

In some embodiments, the semi-solid ion-storing redox compositions include materials proven to work in conventional lithium-ion batteries. In some embodiments, the positive semi-solid electroactive material contains lithium positive electroactive materials and the lithium cations are shuttled between the negative electrode and positive electrode, intercalating into solid, host particles suspended in a liquid electrolyte.

The cathode material 130 is coated on only one side of the cathode current collector 110. Similarly, the anode material 140 is coated on only one side of the anode current collector 120. For example, the semi-solid electrodes can be casted, drop coated, pressed, roll pressed, or otherwise disposed on the current collectors using any other suitable method. Coating the semi-solid electrodes on only one side of the current collectors can substantially reduce the time period for forming the electrochemical cell 100. This can substantially reduce evaporation of the electrolyte included in the cathode material 130 and the anode material 140 slurry formulations. Furthermore, exposure of the electrolyte to the moisture present in the ambient environment can be minimized, thereby preventing degradation of the electrolyte.

A plurality of electrochemical cells 100 can be disposed in a cell stack to form an electrochemical cell stack. For example, the electrochemical cell 100 can be a first electrochemical cell. The cell stack can include a second electrochemical cell (not shown), a third electrochemical cell (not shown), etc. Each of the second electrochemical cell and the third electrochemical cell can be substantially similar to the first electrochemical cell 100. An uncoated surface of a cathode current collector included in the second electrochemical cell can be disposed on an uncoated surface of the cathode current collector 110 included in first electrochemical cell 100. Similarly, an uncoated surface of an anode current collector 120 included in the third electrochemical cell can be disposed on an uncoated surface of the anode current collector 120 included in first electrochemical cell 100. Any number of electrochemical cells 100 can be included in the cell stack. Stacking the plurality of the electrochemical cells 100 as described herein significantly reduces the time required to form the electrochemical cell stack. This can minimize evaporation and/or degradation of the electrolyte as described herein.

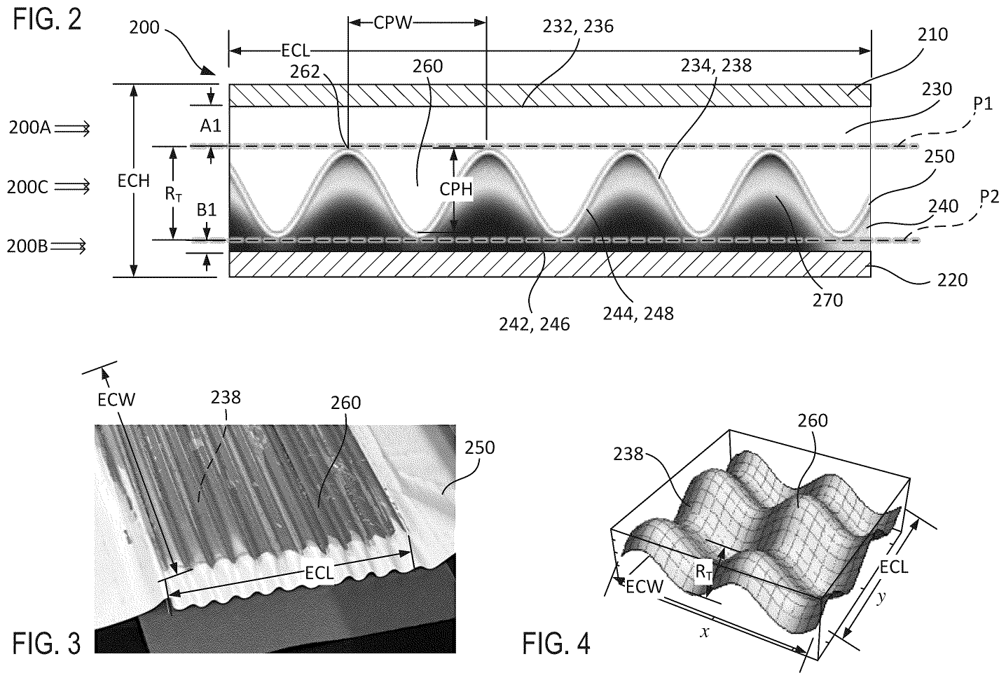

FIG. 2 shows an electrochemical cell 200 having a cathode current collector 210, an anode current collector 220, a cathode material 230, an anode material 240, and a separator 250. In some embodiments, the cathode current collector 210, the anode current collector 220, the cathode material 230, the anode material 240, and the separator 250 can be the same or substantially similar to the cathode current collector 110, the anode current collector 120, the cathode material 130, the anode material 140, and the separator 150, as described above with reference to FIG. 1. Thus, certain aspects of the cathode current collector 210, the anode current collector 220, the cathode material 230, the anode material 240, and the separator 250 are not described in greater detail herein. The cathode material 230 is impressed with a cathode pattern (e.g., profile, texture, etc.), and the anode material 240 is impressed with an anode pattern (e.g., profile, texture, etc.), where the anode pattern is complementary to the cathode pattern such that the cathode material and the anode material mesh together (e.g., fit together, interlock, interlace, interlink, intertwine, interdigitate, etc.) with the separator 250 disposed therebetween. FIGS. 3 and 4 show perspective views of electrodes having two-dimensional and three-dimensional patterns.

The electrochemical cell 200 includes a cell length (e.g., electrochemical cell length) ECL, a cell height (e.g., electrochemical cell height) ECH, and a cell width (e.g., electrochemical cell width) ECW (extending into the page). As can be appreciated, the electrochemical cell 200 may be manufactured such that the ECL, ECH, and ECW have most any measurements. In some implementations, a surface area of the cathode current collector 210 may be so large as to be measured in square meters, or so small as to be measured in square micrometers. For purposes of illustration, various measurements, such as roughness Rₐ, Sₐ, “local minimum,” “local maximum,” and so forth will be described with respect to a portion of the electrochemical cell 200 where the cell length is equal to the cell width (ECL=ECW), and the cell height is equal to 10% of the cell length (ECL=0.1ECH). In some implementations, such as when the ECL is many times larger than ECH, the electrochemical cell 200 may be deformed into a usable shape, such as a cylinder or other prism, and positioned within a case for various uses, such as in a cell phone or car. To avoid confusion when referring to terms such as “local maximum” and “local minimum” for electrochemical cells that are rolled or folded into larger macro shapes, the illustrative electrochemical cell with dimensions ECL×ECL×0.1ECL will be used.

In some embodiments, the electrochemical cell height ECH is at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, or at least about 4 mm. In some embodiments, the electrochemical cell height ECH is no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, or no more than about 100 μm. Combinations of the above-referenced heights (e.g., thicknesses) are also possible (e.g., at least about 100 μm and no more than about 5 mm or at least about 400 μm and no more than about 900 μm), inclusive of all values and ranges therebetween. In some embodiments, the electrochemical cell height ECH is about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, or about 5 mm. In some embodiments, the measurements for ECL and ECW may have substantially the same ranges.

The portion of the electrochemical cell 200 interposed between the cathode current collector 210 and the anode current collector 220 is illustratively divided into three portions: Portion 200A, Portion 200B, and Portion 200C. Portion 200A lies between the cathode current collector 210 and a first plane P1. The first plane P1 is substantially parallel to the cathode current collector 210 and intersects with a local maxima of the separator 250 (e.g., the portion of the separator 250 positioned nearest to the cathode current collector 210; the portion of the anode material 240 nearest to the cathode current collector 210) such that Portion 200A comprises of only cathode material 230. A height of Portion 200A is shown as A1, measured as the distance between the first plane P1 and the cathode current collector 210.

Portion 200B lies between the anode current collector 220 and a second plane P2. The second plane P2 is substantially parallel to the anode current collector 220 and intersects with a local minima of the separator 250 (e.g., a point of the separator 250 positioned nearest to the anode current collector 220; a portion of the cathode material 230 nearest the anode current collector 220) such that Portion 200B includes only anode material 240. A height of Portion 200B is shown as B1, measured as the distance between the second plane P2 and the anode current collector 210.

Portion 200C lies between the first plane P1 and the second plane P2. In some implementations, the first plane P1 is substantially parallel to the second plane P2. The Portion 200C includes the entirety of the separator 250, at least some cathode material 230, and at least some anode material 240. The first plane P1 and the second plane P2 are separated by a distance R_{T}. In other words, R_{T} is the distance between the local profile maximum (e.g., peak) and the local profile minimum (e.g., valley) over the cell length ECL. In some embodiments, the electrochemical cell 200 does not include Portion 200C, such as when the anode material 240 and the cathode material 230 meet at a planar surface (e.g., the separator 250 is planar).

The cathode material 230 includes a first cathode surface 232 and a second cathode surface 234 opposite the first cathode surface 232. The first cathode surface 232 is disposed on the cathode current collector 210, and the second cathode surface 234 abuts the separator 250.

The first cathode surface 232 includes (e.g., is defined by) a first cathode surface profile 236, and the second cathode surface 234 includes a second cathode surface profile 238. In some implementations, the first cathode surface 232 is coupled to the cathode current collector 210 such that the first cathode surface profile 236 is planar or substantially planar.

The cathode material 230 further includes a cathode projection (e.g., protrusion, finger, bump, tooth, etc.) 260 extending in a direction away from the cathode current collector 210. The cathode projection 260 extends between the first plane P1 and the second plane P2. The cathode projection 260 includes a projection width (e.g., cathode projection width) CPW and a projection height (e.g., cathode projection height) CPH. The cathode projection 260 lies entirely within the Portion 200C.

The anode material 240 includes a first anode surface 242 and a second anode surface 244 opposite the first anode surface 242. The first anode surface 242 is disposed on the anode current collector 220, and the second anode surface 244 abuts the separator 250.

The first anode surface 242 includes (e.g., is defined by) a first anode surface profile 246, and the second anode surface 244 includes a second anode surface profile 248. In some implementations, the first anode surface 242 is coupled to the anode current collector 230 such that the first anode surface profile 246 is planar or substantially planar.

The anode material 240 further includes an anode projection (e.g., protrusion, finger, bump, tooth, etc.) 270 extending in a direction away from the anode current collector 230. The anode projection 270 extends between the first plane P1 and the second plane P2. The anode projection 270 includes a projection width (e.g., cathode projection width) CPW and a projection height (e.g., cathode projection height) CPH. The anode projection 270 lies entirely within the Portion 200C.

FIG. 3 shows the second cathode surface profile 238 having a two-dimensional pattern. In some embodiments, the second cathode profile 238 is a corrugated pattern, saw wave pattern, sinusoidal pattern, wave pattern, and the like. In some implementations, the cathode projection 260 is an elongate ridge that extends the entire length ECW of the electrochemical cell 200. In some implementations, the second cathode surface profile 238 has a regular or substantially regular profile that can be expressed as a two-dimensional equation, such as:

$$y = a * sin ( \frac{x}{b} ) , a ∈ , b ∈$$

FIG. 4 shows the second cathode surface profile 238 having a three-dimensional pattern. In some implementations, the cathode projection 260 is a cone, parabolic hill, or the like. In some embodiments, the second cathode surface profile 238 has a regular or substantially regular profile that can be expressed as a three-dimensional equation, such as

$$z = a * sin ( \frac{x}{b} ) + c * sin ( \frac{y}{d} ) ; a , b , c , d ∈ ,$$

where x is a position in a first direction defined along a cathode length, y is a position in a second direction defined along a cathode width perpendicular to the cell length, z is a position in a third direction defined along a cathode height perpendicular to both the cathode length and the cathode width, a is a constant, b is a constant, c is a constant, and d is a constant.

In some embodiments, A1 can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, A1 can be no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced dimensions are also possible (e.g., at least about 10 μm and no more than about 1 mm or at least about 50 μm and no more than about 200 μm), inclusive of all values and ranges therebetween. In some embodiments, A1 can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, B1 can be at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, B1 can be no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, or no more than about 2 μm. Combinations of the above-referenced dimensions are also possible (e.g., at least about 1 μm and no more than about 1 mm or at least about 5 μm and no more than about 200 μm), inclusive of all values and ranges therebetween. In some embodiments, B1 can be about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, R_{T} can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, R_{T} can be no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced dimensions are also possible (e.g., at least about 10 μm and no more than about 1 mm or at least about 50 μm and no more than about 200 μm), inclusive of all values and ranges therebetween. In some embodiments, R_{T} can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, CPH can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, CPH can be no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced dimensions are also possible (e.g., at least about 10 μm and no more than about 1 mm or at least about 50 μm and no more than about 200 μm), inclusive of all values and ranges therebetween. In some embodiments, CPH can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

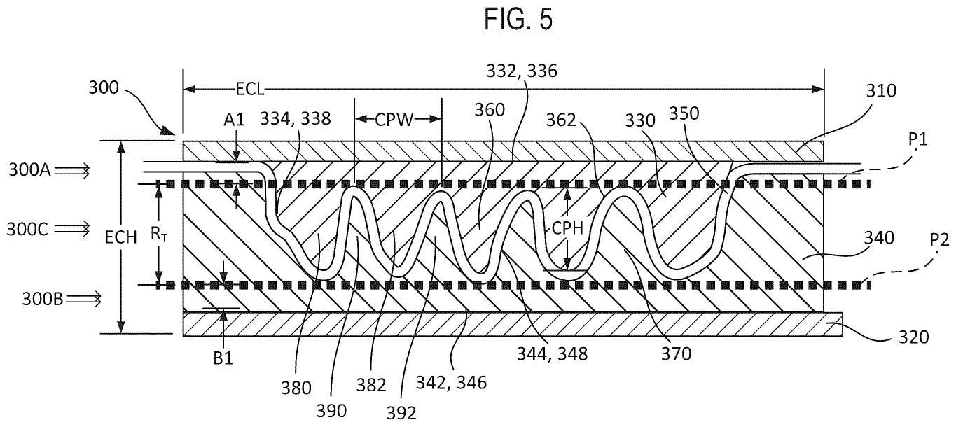

FIG. 5 shows an electrochemical cell 300 having a cathode current collector 310, an anode current collector 320, a cathode material 330, an anode material 340, and a separator 350. In some embodiments, the cathode current collector 310, the anode current collector 320, the cathode material 330, the anode material 340, and the separator 350 can be the same or substantially similar to the cathode current collector 110, the anode current collector 120, the cathode material 130, the anode material 140, and the separator 150, as described above with reference to FIG. 1. Thus, certain aspects of the cathode current collector 310, the anode current collector 320, the cathode material 330, the anode material 340, and the separator 350 are not described in greater detail herein.

The portion of the electrochemical cell 300 interposed between the cathode current collector 310 and the anode current collector 320 is illustratively divided into three portions: Portion 300A, Portion 300B, and Portion 300C. Portion 300A lies between the cathode current collector 310 and a first plane P1. The first plane P1 is substantially parallel to the cathode current collector 310 and intersects with a local maxima of the separator 350 (e.g., the portion of the separator 350 positioned nearest to the cathode current collector 310 or the portion of the anode material 340 nearest to the cathode current collector 310) such that Portion 300A comprises of only cathode material 330. A height of Portion 300A is shown as A1, measured as the distance between the first plane P1 and the cathode current collector 310.

Portion 300B lies between the anode current collector 320 and a second plane P2. The second plane P2 is substantially parallel to the anode current collector 320 and intersects with a local minima of the separator 350 (e.g., a point of the separator 350 positioned nearest to the anode current collector 320, or a portion of the cathode material 330 nearest the anode current collector 320) such that Portion 300B includes only anode material 340. A height of Portion 300B is shown as B1, measured as the distance between the second plane P2 and the anode current collector 310.

Portion 300C lies between the first plane P1 and the second plane P2. In some implementations, the first plane P1 is substantially parallel to the second plane P2. The Portion 300C includes the entirety of the separator 350, at least some cathode material 330, and at least some anode material 340. The first plane P1 and the second plane P2 are separated by a distance R_{T}. In other words, R_{T} is the distance between the local profile maximum (e.g., peak) and the local profile minimum (e.g., valley) over the cell length ECL. In some embodiments, the electrochemical cell 300 does not include Portion 300C, such as when the anode material 340 and the cathode material 330 meet at a planar surface (e.g., the separator 350 is planar).

The cathode material 330 includes a first cathode surface 332 and a second cathode surface 334 opposite the first cathode surface 332. The first cathode surface 332 is disposed on the cathode current collector 310, and the second cathode surface 334 abuts the separator 350.

The first cathode surface 332 includes (e.g., is defined by) a first cathode surface profile 336, and the second cathode surface 334 includes a second cathode surface profile 338. In some implementations, the first cathode surface 332 is coupled to the cathode current collector 310 such that the first cathode surface profile 336 is planar or substantially planar.

The cathode material 330 further includes a cathode projection (e.g., protrusion, finger, bump, tooth, etc.) 360 extending in a direction away from the cathode current collector 310. The cathode projection 360 extends between the first plane P1 and the second plane P2. The cathode projection 360 includes a projection width (e.g., cathode projection width) CPW and a projection height (e.g., cathode projection height) CPH. The cathode projection 360 lies entirely within the Portion 300C. In some implementations, the cathode material 330 includes a first cathode projection 380 and a second cathode projection 382. Both the first cathode projection 380 and the second cathode projection 382 may have irregular profiles. The first cathode projection 380 may have a CPW and a CPH different from that of the second cathode projection 382. In some implementations, the cathode material 330 includes, per ECL, at least about 1 cathode projection, at least about 2 cathode projections, at least about 3 cathode projections, at least about 4 cathode projections, at least about 5 cathode projections, at least about 6 cathode projections, at least about 7 cathode projections, at least about 8 cathode projections, at least about 9 cathode projections, at least about 10 cathode projections, at least about 11 cathode projections, at least about 12 cathode projections, at least about 13 cathode projections, at least about 14 cathode projections, at least about 15 cathode projections, at least about 20 cathode projections, at least about 30 cathode projections, at least about 40 cathode projections, at least about 50 cathode projections, at least about 75 cathode projections, or at least about 100 cathode projections.

In some implementations, the cathode material 330 includes, per ECL, no more than about no more than about 100 cathode projections, no more than about 75 cathode projections, no more than about 50 cathode projections, no more than about 40 cathode projections, no more than about 30 cathode projections, no more than about 20 cathode projections, no more than about 15 cathode projections, no more than about 14 cathode projections, no more than about 13 cathode projections, no more than about 12 cathode projections, no more than about 11 cathode projections, no more than about 10 cathode projections, no more than about 9 cathode projections, no more than about 8 cathode projections, no more than about 7 cathode projections, no more than about 6 cathode projections, no more than about 5 cathode projections, no more than about 4 cathode projections, no more than about 3 cathode projections, no more than about 2 cathode projections, or no more than about 1 cathode projection. Combinations of the above-referenced amounts are also possible (e.g., at least about 1 cathode projection and no more than about 50 cathode projections cm or at least about 4 cathode projections and no more than about 25 cathode projections), inclusive of all values and ranges therebetween. In some implementations, the cathode material 330 includes, per ECL, about 1 cathode projection, about 2 cathode projections, about 3 cathode projections, about 4 cathode projections, about 5 cathode projections, about 6 cathode projections, about 7 cathode projections, about 8 cathode projections, about 9 cathode projections, about 10 cathode projections, about 11 cathode projections, about 12 cathode projections, about 13 cathode projections, about 14 cathode projections, about 15 cathode projections, about 20 cathode projections, about 30 cathode projections, about 40 cathode projections, about 50 cathode projections, about 75 cathode projections, or about 100 cathode projections.

The anode material 340 includes a first anode surface 342 and a second anode surface 344 opposite the first anode surface 342. The first anode surface 342 is disposed on the anode current collector 320, and the second anode surface 344 abuts the separator 350.

The first anode surface 342 includes (e.g., is defined by) a first anode surface profile 346, and the second anode surface 344 includes a second anode surface profile 348. In some implementations, the first anode surface 342 is coupled to the anode current collector 330 such that the first anode surface profile 346 is planar or substantially planar.

The anode material 340 further includes an anode projection (e.g., protrusion, finger, bump, tooth, etc.) 370 extending in a direction away from the anode current collector 330. The anode projection 370 extends between the first plane P1 and the second plane P2. The anode projection 370 includes a projection width (e.g., cathode projection width) CPW and a projection height (e.g., cathode projection height) CPH. The anode projection 270 lies entirely within the Portion 200C. In some implementations, the anode material 340 includes a first anode projection 390 and a second anode projection 390. Both the first anode projection 390 and the second anode projection 392 may have irregular profiles. The first anode projection 390 may have a CPW and a CPH different from that of the second anode projection 392. The anode material 340 may have substantially the same amount of anode projections as the cathode material 330 has cathode projections (e.g., the number of anode projections may be one greater, one less, or equal to the number of cathode projections. In some implementations, each of the anode projections 370 interlocks (e.g., interdigitates) with each of the cathode projections 360.

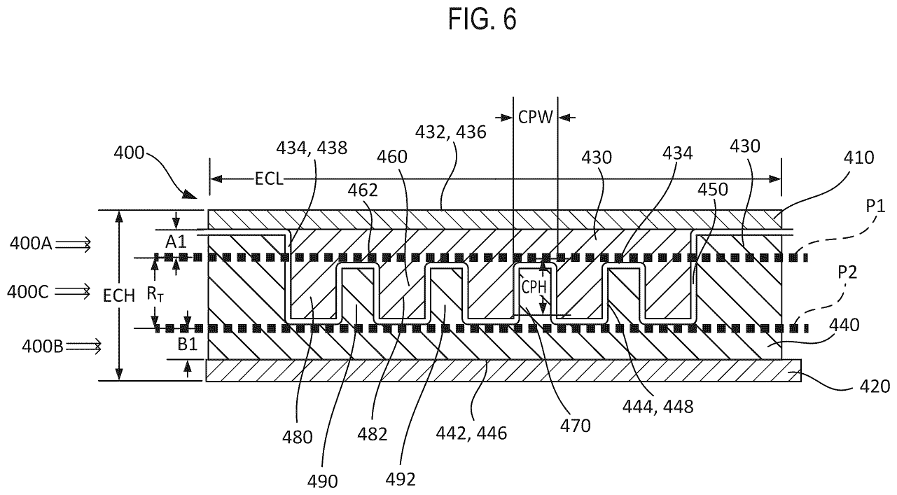

FIG. 6 shows an electrochemical cell 400 having a cathode current collector 410, an anode current collector 420, a cathode material 430, an anode material 440, and a separator 450. In some embodiments, the cathode current collector 410, the anode current collector 420, the cathode material 430, the anode material 440, and the separator 450 can be the same or substantially similar to the cathode current collector 110, the anode current collector 120, the cathode material 130, the anode material 140, and the separator 150, as described above with reference to FIG. 1. Thus, certain aspects of the cathode current collector 410, the anode current collector 420, the cathode material 430, the anode material 440, and the separator 450 are not described in greater detail herein.

The portion of the electrochemical cell 400 interposed between the cathode current collector 410 and the anode current collector 420 is illustratively divided into three portions: Portion 400A, Portion 400B, and Portion 400C. Portion 400A lies between the cathode current collector 410 and a first plane P1. The first plane P1 is substantially parallel to the cathode current collector 410 and intersects with a local maxima of the separator 450 (e.g., the portion of the separator 450 positioned nearest to the cathode current collector 410 or the portion of the anode material 440 nearest to the cathode current collector 310) such that Portion 400A comprises of only cathode material 430. A height of Portion 400A is shown as A1, measured as the distance between the first plane P1 and the cathode current collector 410.

Portion 400B lies between the anode current collector 420 and a second plane P2. The second plane P2 is substantially parallel to the anode current collector 420 and intersects with a local minima of the separator 450 (e.g., a point of the separator 450 positioned nearest to the anode current collector 420 or a portion of the cathode material 430 nearest the anode current collector 420) such that Portion 400B includes only anode material 440. A height of Portion 400B is shown as B1, measured as the distance between the second plane P2 and the anode current collector 410.

Portion 400C lies between the first plane P1 and the second plane P2. In some implementations, the first plane P1 is substantially parallel to the second plane P2. The Portion 400C includes the entirety of the separator 450, at least some cathode material 430, and at least some anode material 440. The first plane P1 and the second plane P2 are separated by a distance R_{T}. In other words, R_{T} is the distance between the local profile maximum (e.g., peak) and the local profile minimum (e.g., valley) over the cell length ECL. In some embodiments, the electrochemical cell 400 does not include Portion 400C, such as when the anode material 440 and the cathode material 430 meet at a planar surface (e.g., the separator 450 is planar).

The cathode material 430 includes a first cathode surface 432 and a second cathode surface 434 opposite the first cathode surface 432. The first cathode surface 432 is disposed on the cathode current collector 410, and the second cathode surface 434 abuts the separator 450.

The first cathode surface 432 includes (e.g., is defined by) a first cathode surface profile 436, and the second cathode surface 434 includes a second cathode surface profile 438. In some implementations, the first cathode surface 432 is coupled to the cathode current collector 410 such that the first cathode surface profile 436 is planar or substantially planar.

The cathode material 430 further includes a cathode projection (e.g., protrusion, finger, bump, tooth, etc.) 460 extending in a direction away from the cathode current collector 410. The cathode projection 460 extends between the first plane P1 and the second plane P2. The cathode projection 460 includes a projection width (e.g., cathode projection width) CPW and a projection height (e.g., cathode projection height) CPH. The cathode projection 460 lies entirely within the Portion 400C. In some implementations, the cathode material 430 includes a first cathode projection 480 and a second cathode projection 482. Both the first cathode projection 480 and the second cathode projection 482 may have irregular profiles. The first cathode projection 480 may have a CPW and a CPH different from that of the second cathode projection 482.

The cathode projection 460 is a square tooth having zero-degree or substantially zero-degree draft angles. The cathode material 430 may include multiple cathode projections 460 that are substantially similar to one another. In some embodiments, each cathode projection 460 is different from each other cathode projection 460.

In some embodiments, the cathode material 460 includes a grid (n×m, where n and m are integers) of cathode projections 460, where the cathode material 460 includes n cathode projections 460 per ECL, and the cathode material 460 includes m cathode projections 460 per ECW. In some implementations, n and m are equal. In some implementations, n and m are different. In some implementations, n is at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 30, at least about 40, at least about 50, at least about 75, or at least about 100.

In some embodiments, n is no more than about 100, no more than about 75, no more than about 50, no more than about 40, no more than about 30, no more than about 20, no more than about 15, no more than about 14, no more than about 13, no more than about 12, no more than about 11, no more than about 10, no more than about 9, no more than about 8, no more than about 7, no more than about 6, no more than about 5, no more than about 4, no more than about 3, no more than about 2, or no more than about 1. Combinations of the above-referenced amounts are also possible (e.g., at least about 1 cathode projection and no more than about 50 cathode projections cm or at least about 4 cathode projections and no more than about 25 cathode projections), inclusive of all values and ranges therebetween.

In some embodiments, n is about 1, about 2, about 3, about 4, about 5, about 6, about 7, about 8, about 9, about 10, about 11, about 12, about 13, about 14, about 15, about 20, about 30, about 40, about 50, about 75, or about 100. The ranges of m are substantially similar to the ranges for n.

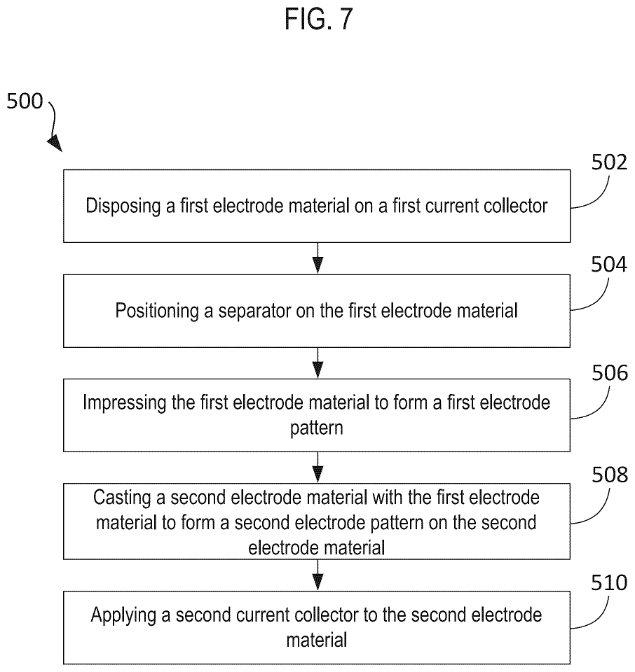

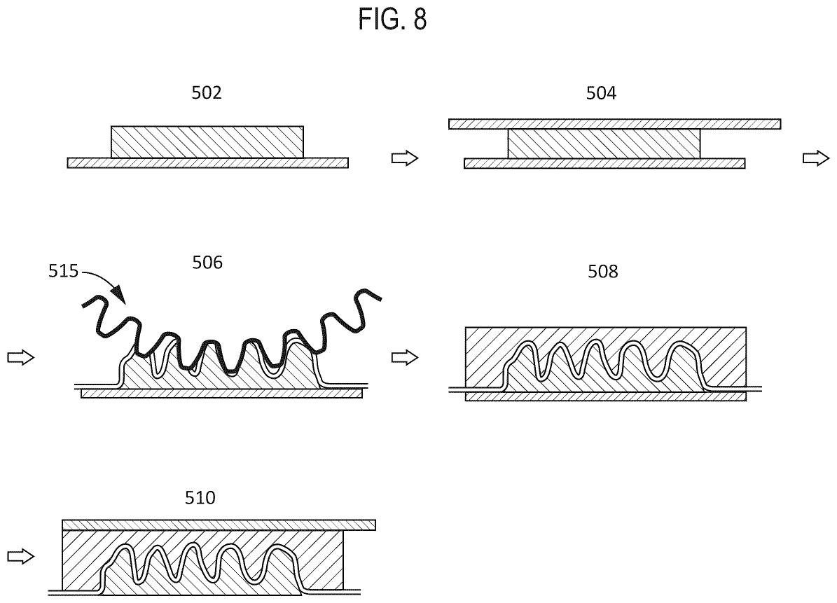

FIGS. 7 and 8 show a method 500 of manufacturing the electrochemical cell of either of FIG. 1, 2, 5, or 6, according to an example implementation. At step 502, a first electrode material—such as the cathode material 130, 230, 330, 430 or the anode material 140, 240, 340, 440—is disposed on (e.g., coupled to, place on, etc.) a first current collector—such as the cathode current collector 110, 210, 310, 410 or the anode current collector 120, 220, 320, 420.

At step 504, a separator, such as the separator 150, 250, 350, 450, is positioned on the first electrode material disposed on the first current collector. The separator may be coupled to the first electrode material. At step 506, the first electrode material is impressed (e.g., embossed, stamped, rolled, deformed, molded, etc.) with an impressing device 515 such that a first electrode pattern is formed on the first electrode material and the separator. The impressing device 515 may be any of a roller, gear, stamp, punch, die, cast, mold, and the like. The step of impressing the first electrode material may be done automatically or manually. In some embodiments, an operator may use multiple impressing tools to create the desired electrode pattern depending on the requirements of the electrochemical cell. For example, portions of the electrochemical cell that will be rolled into the final product may be impressed with a two-dimensional pattern amenable to rolling, while portions of the electrochemical cell known to stay rigid, or requiring increased rigidity, may be impressed with a three-dimensional pattern less amenable to rolling and having increased rigidity.

At step 508, a second electrode material, such as the anode material 140, 240, 340, 440 or the cathode material 130, 230, 330, 430, is casted to (e.g., casted with, impressed with, etc.) the first electrode material such that the second electrode material includes a second electrode pattern complementary to the first electrode pattern and configured to mesh with the first electrode material.

At step 510, a second current collector, such as the anode current collector 120, 220, 320, 420 or the cathode current collector 110, 210, 310, 410, is disposed on the second electrode material.

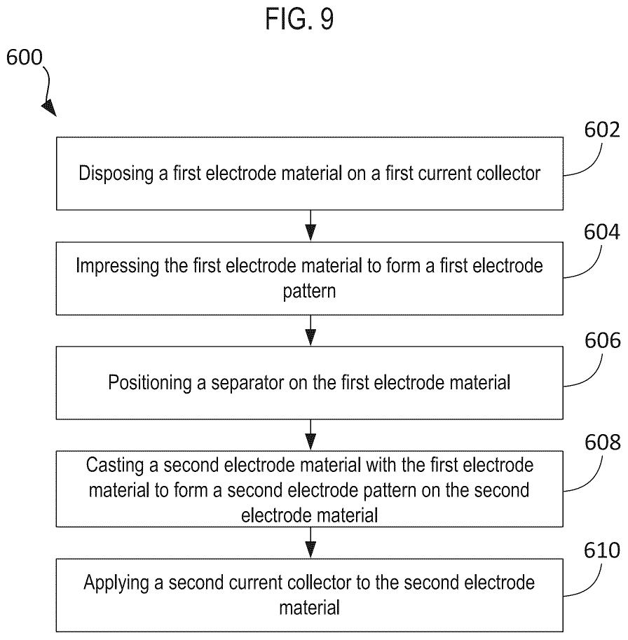

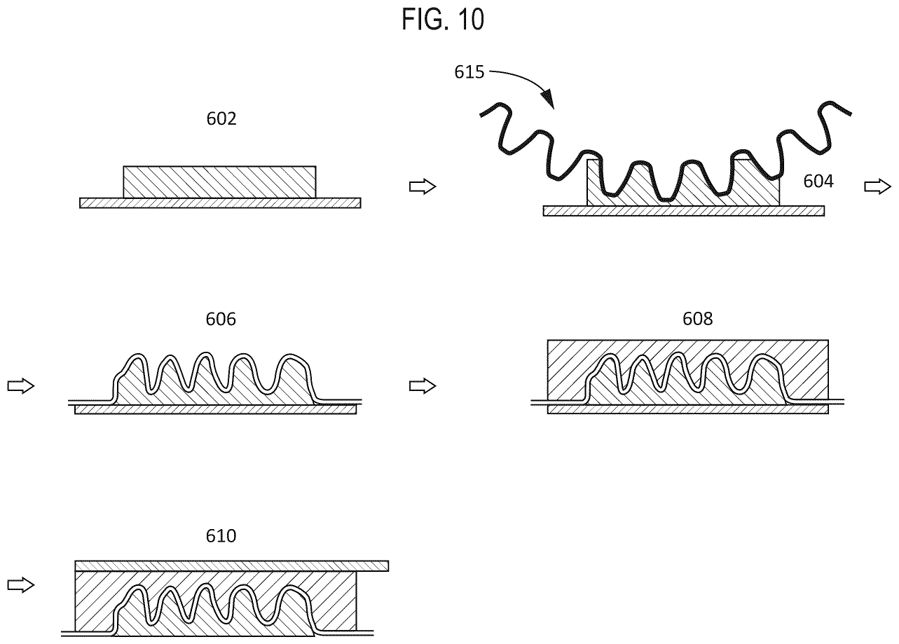

FIGS. 9 and 10 show a method 600 of manufacturing the electrochemical cell of any of FIG. 1, 2, 5, or 6, according to an example implementation. At step 602, a first electrode material, such as the cathode material 130, 230, 330, 430 or the anode material 140, 240, 340, 440, is disposed on (e.g., coupled to, place on, etc.) a first current collector, such as the cathode current collector 110, 210, 310, 410 or the anode current collector 120, 220, 320, 420.

At step 604, the first electrode material is impressed (e.g., embossed, stamped, rolled, deformed, molded, etc.) with an impressing device 615 such that a first electrode pattern is formed on the first electrode material. The impressing device 615 may be any of a roller, gear, stamp, punch, die, cast, mold, and the like. The step of impressing the first electrode material may be done automatically or manually. In some embodiments, an operator may use multiple impressing tools to create the desired electrode pattern depending on the requirements of the electrochemical cell. For example, portions of the electrochemical cell that will be rolled into the final product may be impressed with a two-dimensional pattern amenable to rolling, while portions of the electrochemical cell known to stay rigid, or requiring increased rigidity, may be impressed with a three-dimensional pattern less amenable to rolling and having increased rigidity. A lubricant may be applied to the impressing device 615 to decrease the friction between the impressing device 615 and the first electrode material during impressing. In some embodiments, the step of impressing the first electrode material facilitates the discharge of electrolyte from the first electrode material.

At step 606, a separator, such as the separator 150, 250, 350, 450, is positioned on the first electrode material disposed on the first current collector such that the separator takes the form of the first electrode pattern. In some implementations, the first electrode material and the separator are impressed a second time after the separator is disposed on the first electrode material.

At 608, a second electrode material, such as the anode material 140, 240, 340, 440 or the cathode material 130, 230, 330, 430, is casted to (e.g., casted with, impressed with, etc.) the first electrode material such that the second electrode material includes a second electrode pattern complementary to the first electrode pattern and configured to mesh with the first electrode material.

At 610, a second current collector, such as the anode current collector 120, 220, 320, 420 or the cathode current collector 110, 210, 310, 410, is disposed on the second electrode material.

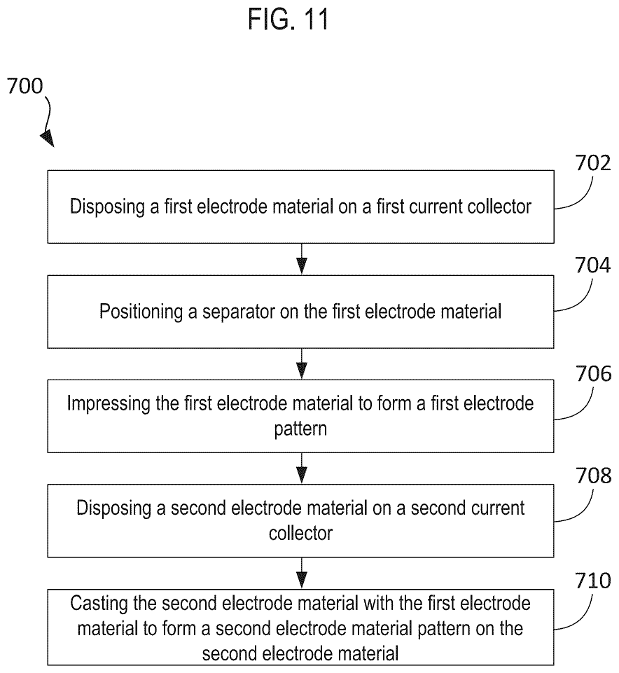

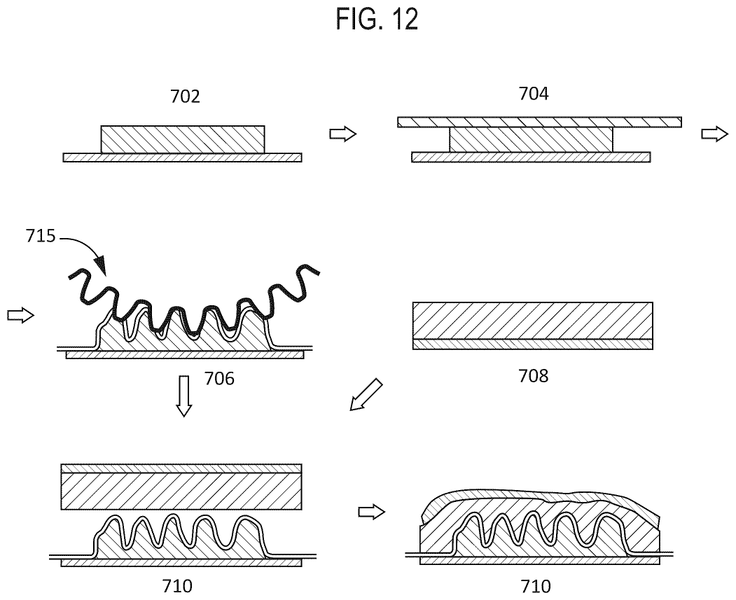

FIGS. 11 and 12 show a method 700 of manufacturing the electrochemical cell of any of FIG. 1, 2, 5, or 6, according to an example implementation. At step 702, a first electrode material, such as the cathode material 130, 230, 330, 430 or the anode material 140, 240, 340, 430, is disposed on (e.g., coupled to, place on, etc.) a first current collector, such as the cathode current collector 110, 210, 310, 410 or the anode current collector 120, 220, 320, 420.

At step 704, a separator, such as the separator 150, 250, 350, 450, is positioned on the first electrode material disposed on the first current collector.

At step 706, the first electrode material is impressed (e.g., embossed, stamped, rolled, deformed, molded, etc.) with an impressing device 715 such that a first electrode pattern is formed on the first electrode material and the separator. The impressing device 715 may be any of a roller, gear, stamp, punch, die, cast, mold, and the like. A lubricant may be applied to the impressing device 715 to decrease the friction between the impressing device 715 and the separator during impressing. In some embodiments, the step of impressing the first electrode material facilitates the discharge of electrolyte from the first electrode material. The step of impressing the first electrode material may be done automatically or manually. In some embodiments, an operator may use multiple impressing tools to create the desired electrode pattern depending on the requirements of the electrochemical cell. For example, portions of the electrochemical cell that will be rolled into the final product may be impressed with a two-dimensional pattern amenable to rolling, while portion of the electrochemical cell known to stay rigid, or requiring increased rigidity, may be impressed with a three-dimensional pattern less amenable to rolling and having increased rigidity.

At step 708, a second electrode material, such as the anode material 140, 240, 340, 440 or the cathode material 130, 230, 330, 430, is disposed on a second current collector, such as the anode current collector 120, 220, 320, 420 or the cathode current collector 110, 210, 310, 410.

At step 710, the second electrode material is casted to (e.g., casted with, impressed with, etc.) the first electrode material while the second current collector is coupled to the second electrode material such that the second electrode material includes a second electrode pattern complementary to the first electrode pattern and such that the second electrode material is configured to mesh with the first electrode material. The step of casting the second electrode material to the first electrode material may be completed by positioning all of the first electrode material, first current collector, separator, pre-casted (e.g., uncasted) second electrode material, and the second current collector into a pouch and withdrawing the air form the pouch such that the atmospheric pressure forces the second electrode material into the first electrode material, thus casting the second electrode material. Other advantages of using a vacuum pouch to cast the second electrode material include removing excess air from between the various contact points within the electrochemical cell, including removing excess air from the contact between the first current collector and the first electrode material, the contact between the first electrode material and the separator, the contact between the separator and the second electrode material, and the contact between the second electrode material and the second current collector. In some embodiments, one or both of the first current collector and the second current collector deform under the pressure from the vacuum pouch.

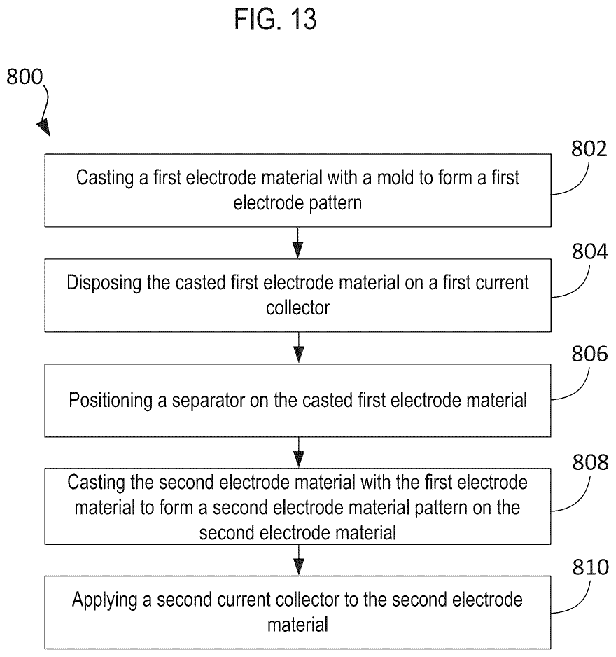

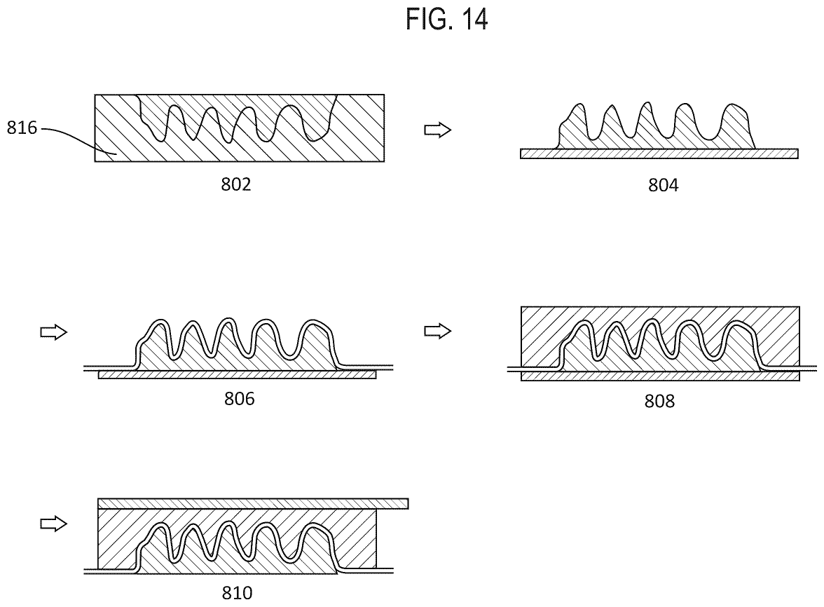

FIGS. 13 and 14 show a method 800 of manufacturing the electrochemical cell of any of FIG. 1, 2, 5, or 6, according to an example implementation. At step 802, a first electrode material, such as the cathode material 130, 230, 330, 430 or the anode material 140, 240, 340, 440, is disposed in and casted in a mold 816 to form a casted first electrode material having a first cathode pattern and configured for coupling to a current collector.

At step 804, the casted first electrode material is demolded and positioned on a first current collector, such as the cathode current collector 110, 210, 310, 410 or the anode current collector 120, 220, 320, 420.

At step 806, a separator, such as the separator 150, 250, 350, 450, is positioned on the casted first electrode material disposed on the first current collector such that the separator takes the form of the first electrode pattern. In some implementations, the casted first electrode material and the separator are impressed after the separator is disposed on the first electrode material to facilitate formation of the separator to the first electrode pattern.

At step 808, a second electrode material, such as the anode material 140, 240, 340, 440 or the cathode material 130, 230, 330, 430, is casted to (e.g., casted with, impressed with, etc.) the first electrode material such that the second electrode material includes a second electrode pattern complementary to the first electrode pattern and configured to mesh with the first electrode material.

At step 810, a second current collector, such as the anode current collector 120, 220, 320, 420 or the cathode current collector 110, 210, 310, 410, is disposed on the second electrode material.

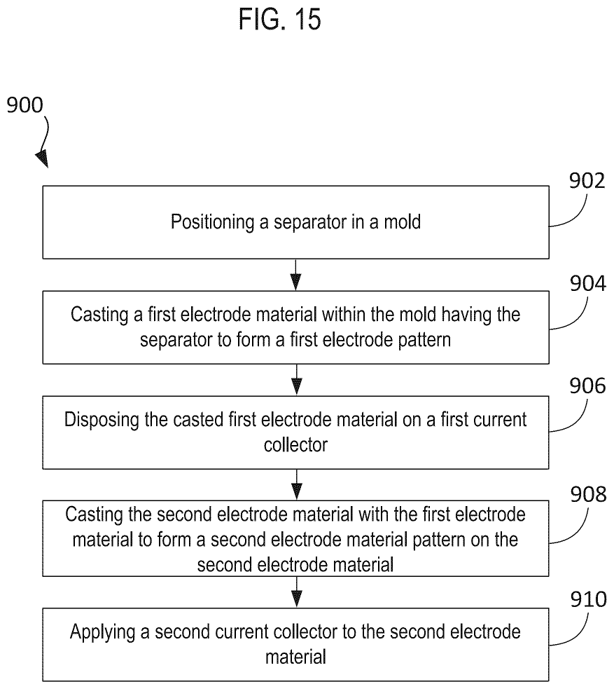

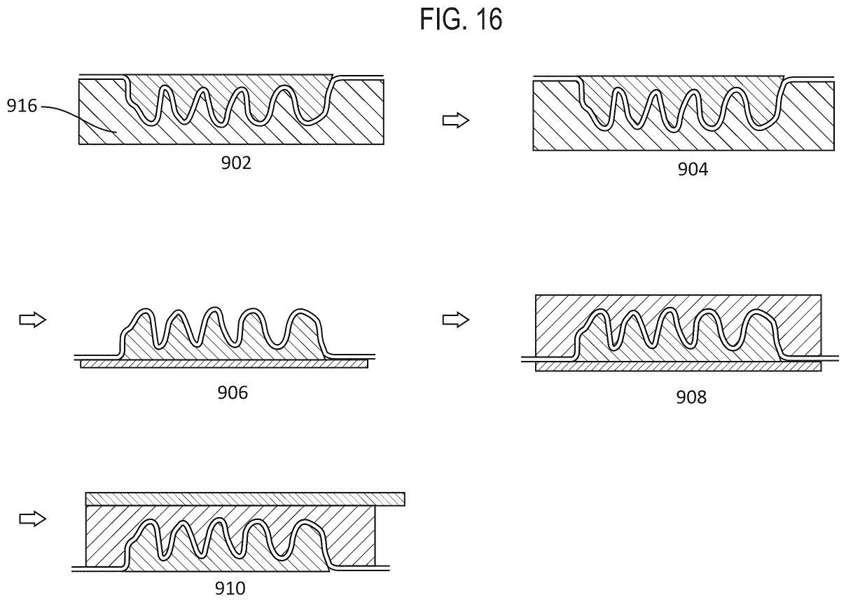

FIGS. 15 and 16 show a method 900 of manufacturing the electrochemical cell of FIGS. 1-6, according to an example implementation.

At step 902, a separator—such as the separator 150, 250, 350, 450—is positioned within a mold (e.g., cast, form, etc.) 916. A lubricant may be interposed between the separator and the mold 916 to reduce the friction between the mold 916 and the separator.

At step 904, a first electrode material, such as the cathode material 130, 230, 330, 430 or the anode material 140, 240, 340, 440, is disposed in and casted in the mold 916 to form a casted first electrode material having a first cathode pattern and configured for coupling to a current collector.

At step 906, the casted first electrode material is demolded and positioned on a first current collector, such as the cathode current collector 110, 210, 310, 410 or the anode current collector 120, 220, 320, 420.

At step 908, a second electrode material, such as the anode material 140, 240, 340, 440 or the cathode material 130, 230, 330, 430, is casted to (e.g., casted with, impressed with, etc.) the first electrode material such that the second electrode material includes a second electrode pattern complementary to the first electrode pattern and configured to mesh with the first electrode material.

At step 910, a second current collector, such as the anode current collector 120, 220, 320, 420 or the cathode current collector 110, 210, 310, 410, is disposed on the second electrode material.

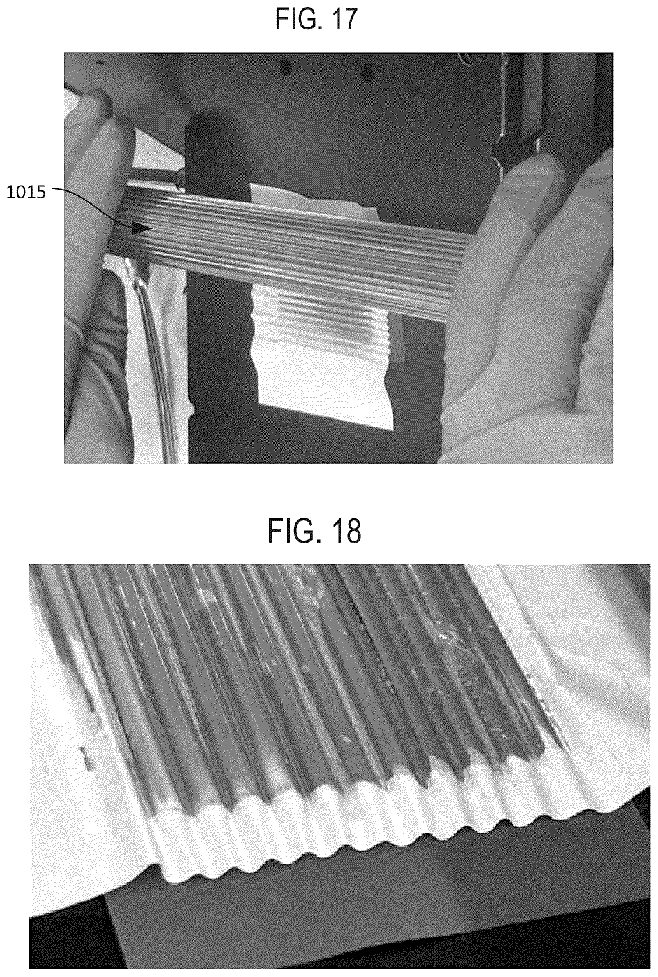

FIGS. 17-20 show example steps 502, 504, 506, 508, 510 of method 500 of manufacturing the electrochemical cell of any of FIG. 1, 2, 5, or 6. FIG. 17 shows a separator, such as the separator 150, 250, 350, 450, is positioned on the first electrode material disposed on the first current collector.

An impressing device 1015, shown as a ridged roller, is shown manually rolled over the separator and the first cathode material to impress a first cathode pattern into the first cathode material and the separator. A zoomed in perspective view of the separator having the first cathode pattern is shown in FIG. 18.

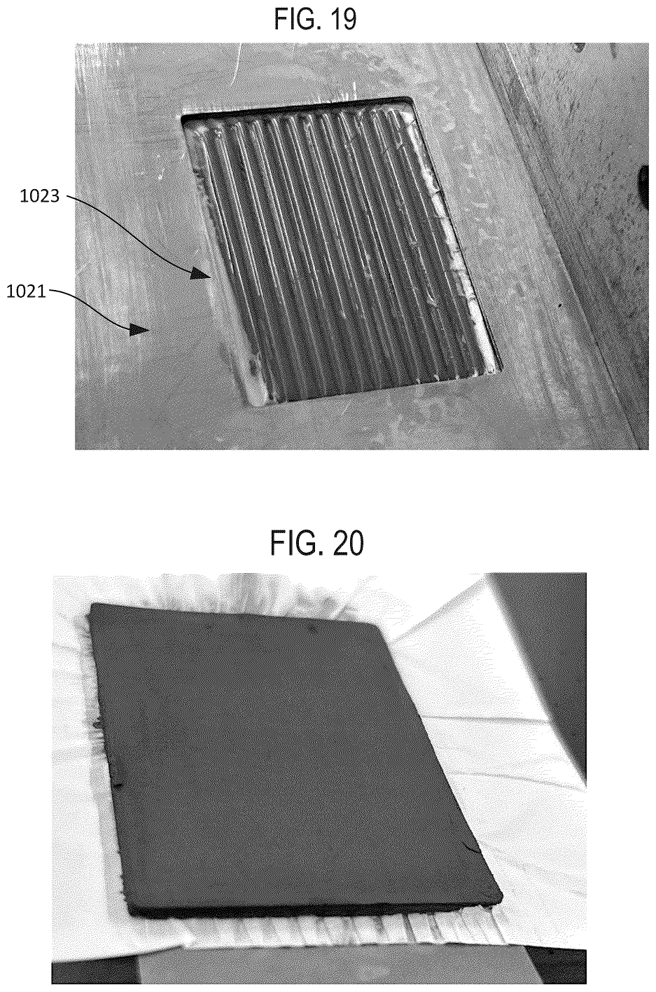

FIG. 19 shows a cast 1021 positioned over the first cathode material and the separator, the cast 1021 having an opening 1023 configured to receive a semi-solid material for casting.

FIG. 20 shows a second electrode material, such as the anode material 140, 240, 340, 440 or the cathode material 130, 230, 330, 430, casted to (e.g., casted with, impressed with, etc.) the first electrode material such that the second electrode material includes a second electrode pattern complementary to the first electrode pattern and configured to mesh with the first electrode material.

### EXAMPLES

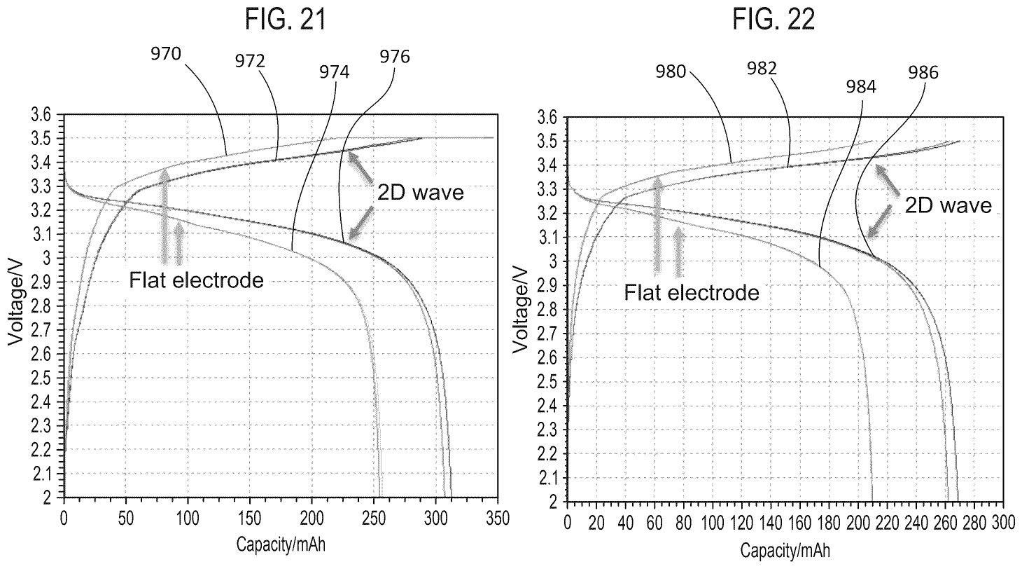

FIGS. 21 and 22 show battery charge and battery discharge curves comparing the charge capacity of batteries having flat electrodes to the charge capacity of batteries having two-dimensional electrodes. Each of the four test electrochemical cells has the same footprint and the same cathode mass.

FIG. 21 shows the first charge cycle and the first discharge cycle of four test electrochemical cells. Lines 970 and 974 correspond to electrochemical cells having flat electrodes. Lines 972 and 976 correspond to electrochemical cells having electrodes with two-dimensional patterns. As shown comparing lines 970 and 972, the electrochemical cells having a two-dimensional wave-patterned electrodes have a higher charging capacity at each voltage during charging compared to the electrochemical cells having flat electrodes. Likewise, as shown comparing lines 974 and 976, the electrochemical cells having a two-dimensional wave-patterned electrodes have a higher charging capacity at each voltage during discharge compared to the electrochemical cells having flat electrodes.

FIG. 22 shows the third charge cycle and the third discharge cycle of four test electrochemical cells. Lines 980 and 984 correspond to electrochemical cells having flat electrodes. Lines 982 and 986 correspond to electrochemical cells having electrodes with two-dimensional patterns. As shown comparing lines 980 and 982, the electrochemical cells having a two-dimensional wave-patterned electrodes have a higher charging capacity at each voltage during a third cycle of charging compared to the electrochemical cells having flat electrodes. Likewise, as shown comparing lines 984 and 986, the electrochemical cells having a two-dimensional wave-patterned electrodes have a higher charging capacity at each voltage during a third discharge cycle compared to the electrochemical cells having flat electrodes.

Table 1 compares the charge capacity, the coulombic efficiency, and the energy efficiency of the four test electrochemical cells having electrodes with a two-dimensional wave shape and a flat shape.

TABLE 1
Comparing Cell Performance with Varying Electrode Shapes

| Cathode Shape | 2D Wave | Flat |
|---|---|---|
| First Charge Capacity | 22.1-22.6 mAh/cm² | 18.3 mAh/cm² |
| First cycle coulombic | 90.1-90.5% | 90.7-91.2% |
| efficiency | | |
| Third cycle energy efficiency | 92.1-92.4% | 91.3-91.4% |
| C/20 CC cycle | | |

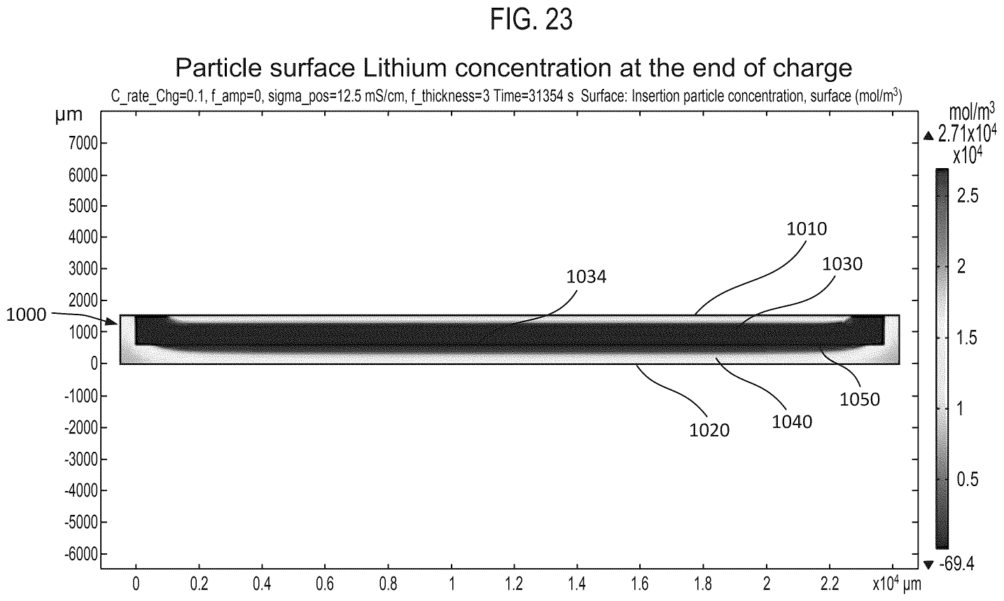

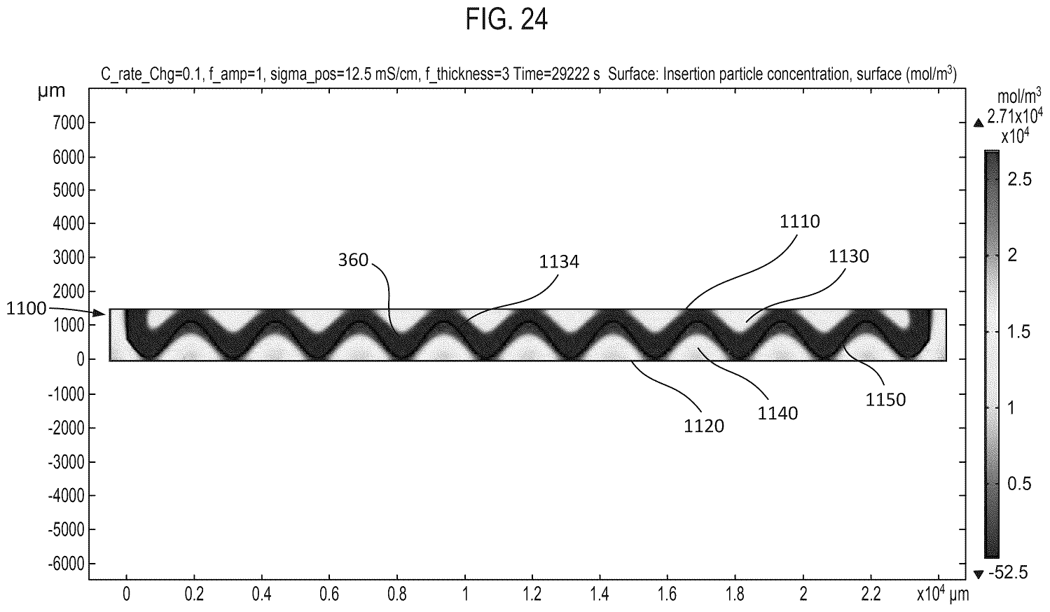

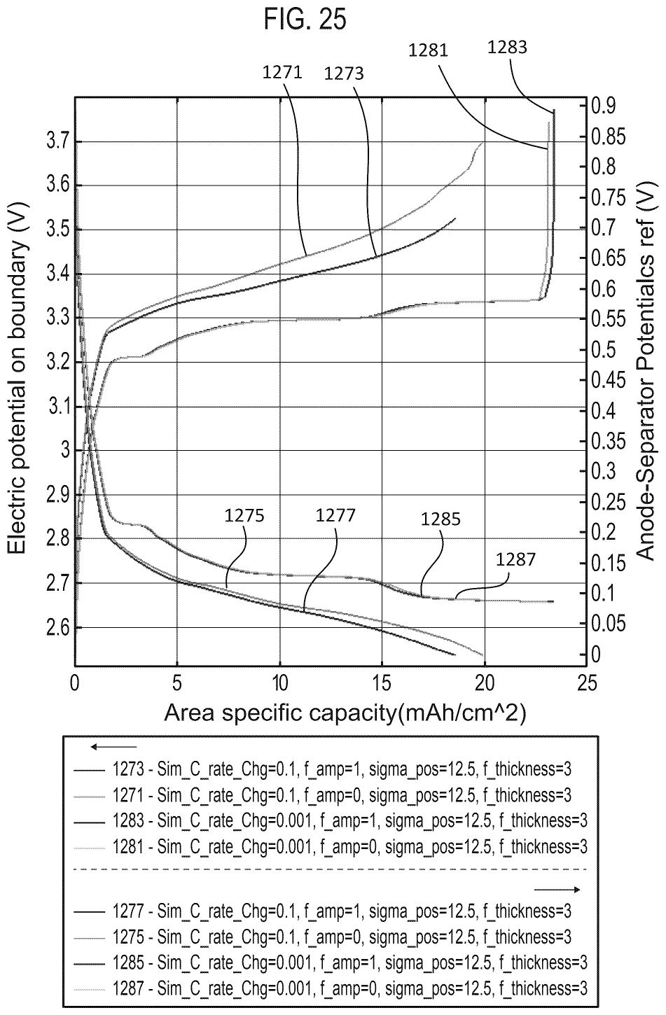

FIGS. 23 and 24 show the particle surface lithium concentration (simulated via COMSOL Multiphysics) of a test electrochemical ell at the end of a charge cycle. FIG. 25 shows the area specific capacity (mAh/cm²) for the test electrochemical cells shown in FIGS. 23 and 24 during charging and discharging.

FIG. 23 shows a first electrochemical cell, referred to as a first test cell 1000. The first test cell 1000 includes a cathode current collector 1010, an anode current collector 1020, a cathode material 1030, an anode material 1040, and a separator 1050. In some embodiments, the cathode current collector 1010, the anode current collector 1020, the cathode material 1030, the anode material 1040, and the separator 1050 can be the same or substantially similar to the cathode current collector 110, the anode current collector 120, the cathode material 130, the anode material 140, and the separator 150, as described above with reference to FIG. 1. Thus, certain aspects of the cathode current collector 1010, the anode current collector 1020, the cathode material 1030, the anode material 1040, and the separator 1050 are not described in greater detail herein.

A second cathode surface 1034 of the second cathode material 1030 is substantially flat and planar. In other words, R_{T} is equal to zero. The ECL of the first test cell 1000 is 25 millimeters and the ECH is 1.5 millimeters. The height of Portion 1000A is 900 μm and the height of Portion 1000B is 600 μm. The height of Portion 1000C is 0 μm (e.g., there is no Portion 1000C).

FIG. 24 shows a second electrochemical cell, referred to as a second test cell 1100. The second test cell 1100 includes a cathode current collector 1110, an anode current collector 1120, a cathode material 1130, an anode material 1140, and a separator 1150. In some embodiments, the cathode current collector 1110, the anode current collector 1120, the cathode material 1130, the anode material 1140, and the separator 1150 can be the same or substantially similar to the cathode current collector 110, the anode current collector 120, the cathode material 130, the anode material 140, and the separator 150, as described above with reference to FIG. 1. Thus, certain aspects of the cathode current collector 1110, the anode current collector 1120, the cathode material 1130, the anode material 1140, and the separator 1150 are not described in greater detail herein.

A second cathode surface 1134 of the second cathode material 1130 includes a two-dimensional pattern having ten projections 1160 per ECL, where the ECL of the second test cell 1100 is 25 mm. Each of the ten projections 1160 has a CPH of approximately 1138 μm. Each of the ten projections 1160 has a CPW of approximately 2.5 mm. In some implementations, the CPW of the ten projections 1160 is slightly less than 2.5 mm, such as 2.3 mm, 2.4 mm, or 2.47 mm.

The ECH of the second test cell 1100 is 1.5 mm. The height of Portion 1100A is approximately 334 μm. The height of Portion 1100B is approximately 28 μm. The height of Portion 1100C (e.g., R_{T}) is approximately 1138 μm.

The first test cell 1000 and the second test cell 1100 include the same mass of cathode material and anode material, and both cells have the same ECL and ECH.

FIG. 25 shows simulated full cell voltage and anode-separator interphase potential for areal capacity (mAh/cm²) for the test electrochemical cells shown in FIGS. 23 and 24 during charging and discharging. Line 1271 shows the area specific capacity of the first test cell 1000 when charged at a rate of C/10 (0.1 C). Line 1273 shows the area specific capacity of the second test cell 1100 when charged at a rate of C/10 (0.1 C). At each electric potential starting around 3.27 volts, the second test cell 1100 has a greater area specific capacity than the first test cell 1000. Put another way, the second test cell 1100 has a greater charge capacity than the first test cell 1000.

Line 1281 shows the simulated area specific capacity of the first test cell 1000 when charged at a rate of C/1000 (0.001 C). Line 1283 shows the area specific capacity of the second test cell 1100 when charged at a rate of C/1000 (0.001 C). At each electric potential starting around 3.35 volts, the second test cell 1100 has a greater area specific capacity than the first test cell 1000. Put another way, the second test cell 1100 has a greater charge capacity than the first test cell 1000.

Line 1275 shows a simulated lowest anode/separator interface potential when the full cell is charged at a rate of C/10 (0.1 C). Line 1277 shows a simulated lowest anode/separator interface potential when a full cell is charged at a rate of C/10 (0.1 C). As shown, the second simulated cell 1100 does not have the same charging ability as the first simulated cell 1000 in terms of the lithium plating limitation at the anode/separator interface.

Line 1285 is a simulated lowest anode/separator interface potential when the full cell is charged at a rate of C/1000 (0.001 C). Line 1287 shows a simulated lowest anode/separator interface potential when the full cell is charged at a rate of C/1000 (0.001 C). At each electric potential, the second test cell 1100 and the first test cell 1000 have a substantially similar area specific capacity.

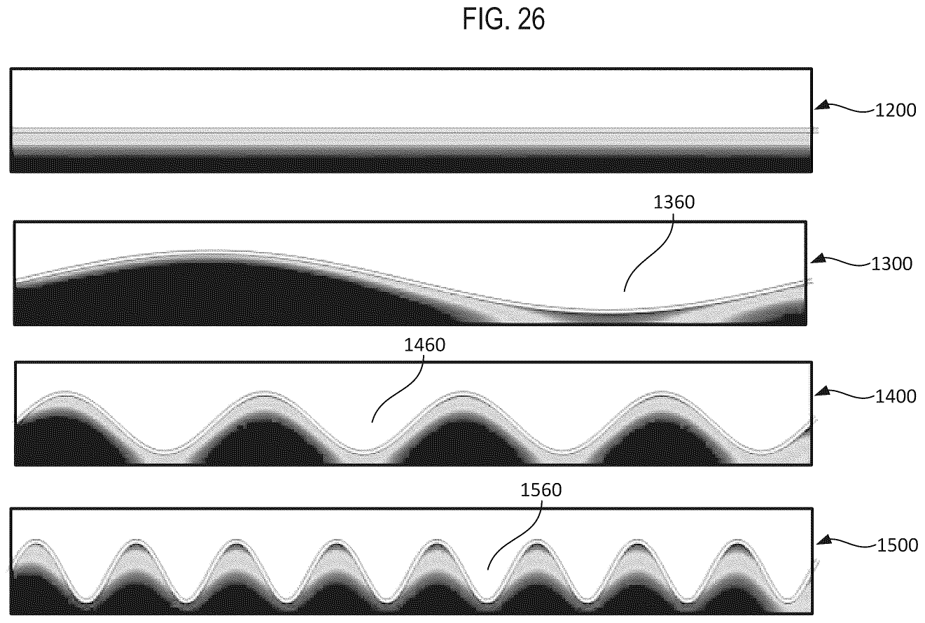

FIG. 26 shows example electrochemical cells, shown as a third test cell 1200, a fourth test cell 1300, a fifth test cell 1400, and a sixth test cell 1500, similar to the electrochemical cell 100 of FIG. 1. Each of the third test cell 1200, the fourth test cell 1300, the fifth test cell 1400, and the sixth test cell 1500 has an ECL of 4 mm and an ECH of 0.5 mm. The third test cell 1300 has a Portion A height (e.g., portion 300A from FIG. 5) of 300 μm and a Portion B (e.g., portion 300B from FIG. 5) height of 200 μm. The Portion C (e.g., portion 300C from FIG. 5) has a height of 0 μm (e.g., the third test cell 1200 does not include the Portion C). The fourth test cell 1300, the fifth test cell 1400, and the sixth test cell 1500 have an R_{T} of 360 μm.

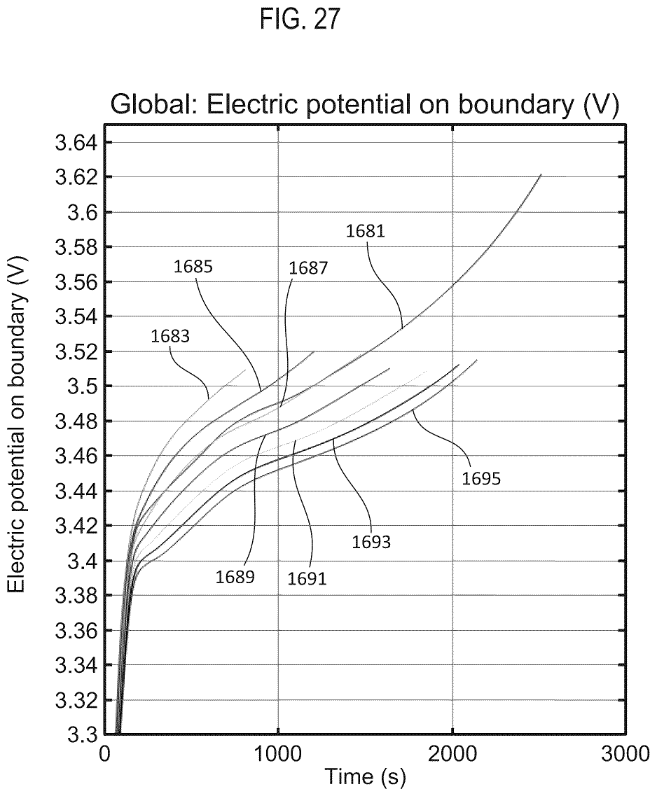

FIG. 27 shows a chart of simulated electric potential on the boundary between the cathode and the anode for various test electrochemical cells charged until the anode/separator interface reaches 0 V. Cells requiring more time to reach a certain electric potential at the boundary have a higher energy capacity (the electrochemical cell corresponding to Line 1695 has the greatest energy capacity of the tested cells). Line 1681 corresponds to the third test cell 1200 shown in FIG. 26 having a flat and planar interface between the cathode material and the anode material. Line 1683 corresponds to the fourth test cell 1300 having an R_{T} of 360 μm. The fourth test cell 1300 has one projection 1360 having a CPH of 360 μm. In some implementations, the second cathode surface 1332 of the fourth test cell 1300 is defined by a two-dimensional wave pattern having a period of 4 mm and an amplitude of 180 μm. The fourth test cell 1300 (Line 1683), when charged at a rate of 1 C, reaches 3.51 volts faster than the third test cell 1200. Accordingly, the fourth test cell 1300 has a lower charging capacity than the third test cell 1200.

Line 1685 corresponds to a test cell having two projections, each of the two projections having a CPH of 360 μm. A second cathode surface of the test cell may be defined by a two-dimensional wave pattern having a period of 2 mm and an amplitude of 180 μm. The test cell having two projections (Line 1685), when charged at a rate of 1 C, reaches 3.51 volts faster than the third test cell 1200. Accordingly, the test cell having two projections has a lower charging capacity than the third test cell 1200.

Line 1687 corresponds to a test cell having three projections, each of the three projections having a CPH of 360 μm. A second cathode surface of the test cell may be defined by a two-dimensional wave pattern having a period of 1.33 mm and an amplitude of 180 μm. The test cell having three projections (Line 1687), when charged at a rate of 1 C, reaches 3.51 volts at about the same speed as the third test cell 1200. Accordingly, the test cell having three projections has approximately the same charging capacity as the third test cell 1200.

Line 1689 corresponds to the fifth test cell 1400 shown in FIG. 26. The fifth test cell 1400 has four projections 1460 having a CPH of 360 μm. In some implementations, the second cathode surface 1432 of the fifth test cell 1400 is defines by a two-dimensional wave pattern having a period of 1 mm and an amplitude of 180 μm. The fifth test cell 1400 (Line 1689), when charged at a rate of 1 C, reaches 3.51 volts slower than the third test cell 1200 having a planar second cathode surface 1232. Accordingly, the fifth test cell 1400 has a greater charging capacity than the third test cell 1200.

Line 1691 corresponds to a test cell having five projections, each of the five projections having a CPH of 360 μm. A second cathode surface of the test cell may be defined by a two-dimensional wave pattern having a period of 0.8 mm and an amplitude of 180 μm. The test cell having five projections (Line 1691), when charged at a rate of 1 C, reaches 3.51 volts slower than the third test cell 1200. Accordingly, the test cell having five projections has a greater charging capacity than the third test cell 1200.

Line 1693 corresponds to a test cell having six projections, each of the six projections having a CPH of 360 μm. A second cathode surface of the test cell may be defined by a two-dimensional wave pattern having a period of 0.66 mm and an amplitude of 180 μm. The test cell having six projections (Line 1693), when charged at a rate of 1 C, reaches 3.51 volts slower than the third test cell 1200. Accordingly, the test cell having six projections has a greater charging capacity than the third test cell 1200.

Line 1616 corresponds to a test cell having seven projections, each of the seven projections having a CPH of 360 μm. A second cathode surface of the test cell may be defined by a two-dimensional wave pattern having a period of approximately 0.57 mm and an amplitude of 180 μm. The test cell having two projections (Line 1695), when charged at a rate of 1 C, reaches 3.51 volts slower than the third test cell 1200. Accordingly, the test cell having seven projections has a greater charging capacity than the third test cell 1200.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrode comprising:
a first electrode surface having a first electrode surface profile, the first electrode surface configured for coupling to a current collector, and the first electrode profile being substantially flat and planar; and
a second electrode surface having a second electrode surface profile, the second electrode surface being opposite to the first electrode surface, the second electrode surface profile comprising a plurality of projections extending in a direction away from the first electrode surface.

2. The electrode of claim 1, wherein the second electrode surface profile is defined by:
a first plane parallel to the first electrode surface and intersecting a local minimum point of the second electrode surface profile, the local minimum point of the second electrode surface profile being a point of the second electrode surface profile positioned nearest the first electrode surface; and
a second plane parallel to the first electrode surface and intersecting a local maximum point of the second electrode surface profile, the local maximum point of the second electrode surface profile being a point of the second electrode surface profile positioned furthest from the first electrode surface.

3. The electrode of claim 2, wherein the plurality of projections includes an electrode projection having:
a projection base proximate the first plane; and
a projection top proximate the second plane.

4. The electrode of claim 1, wherein the second electrode surface profile is defined by a sinusoidal equation.

5. The electrode of claim 1, wherein the second electrode surface profile is substantially defined by the equation:
$$z = a * sin ( \frac{x}{b} ) + c * sin ( \frac{y}{d} ) ,$$
where:
x is a position in a first direction defined along a length of the second electrode,
y is a position in a second direction defined along a width of the second electrode perpendicular to the length of the second electrode,
z is a position in a third direction defined along a height of the second electrode perpendicular to both the length and the width of the second electrode,
a is a constant;
b is a constant;
c is a constant, and
d is a constant.

6. The electrode of claim 2, wherein the distance between the first plane and the second plane is greater than a distance between the first plane and the first electrode surface.

7. The electrode of claim 2, wherein the distance between the first plane and the second plane is at least two times the distance between the first plane and the first electrode surface.

8. An electrode comprising:
a current collector;
a semi-solid electrode material disposed on the current collector, the semi-solid electrode having:
a first surface abutting the current collector and having a first surface profile that is substantially flat and planar; and
a second surface opposite to the first surface and having a second surface profile comprising a plurality of projections extending in a direction away from the first surface; and
a separator coupled to the semi-solid electrode and covering an entirely of the second surface.

9. The electrode of claim 8, wherein the second surface profile is defined by:
a first plane parallel to the current collector and intersecting a local minimum point of the second surface profile, the local minimum point of the second surface profile being a point of the second surface profile positioned nearest the current collector; and
a second plane parallel to the current collector and intersecting a local maximum point of the second surface profile, the local maximum point of the second surface profile being a point of the second surface profile positioned furthest from the current collector.

10. The electrode of claim 9, wherein the plurality of projections lie within a space defined between the first plane and the second plane.

11. The electrode of claim 10, wherein the plurality of projections includes at least about three projections and no more than about 100 projections.

12. The electrode of claim 10, wherein the plurality of projections includes a projection height defined by a distance between the first plane and the second plane.

13. The electrode of claim 12, wherein the projection height is at least about 10 μm and no more than about 1 mm.

14. The electrode of claim 13, wherein the projection height is at least about 100 μm and no more than about 500 μm.

15. The electrode of claim 8, wherein the plurality of projections define a two-dimensional pattern including at least one of a corrugated pattern, a wave pattern, a saw wave pattern, or a sinusoidal pattern.

16. An electrochemical cell comprising:
a cathode current collector;
an anode current collector;
a cathode material disposed on the cathode current collector, the cathode material comprising:
a first cathode surface abutting the cathode current collector and having a first cathode surface profile that is substantially flat and planar; and
a second cathode surface opposite to the first cathode surface and having a second cathode surface profile comprising a plurality of projections extending in a direction away from the first cathode surface;
an anode material disposed on the anode current collector, the anode material comprising:
a first anode surface abutting the anode current collector and having a first anode surface profile that is substantially flat and planar; and
a second anode surface opposite the first anode surface and having a second anode profile complementary to the second cathode surface profile such that the second anode surface and the second cathode surface mesh together; and
a separator interposed between the anode material and the cathode material.

17. The electrochemical cell of claim 16, wherein the ion-permeable membrane conforms to both the second anode surface profile and the second cathode surface profile.

18. The electrochemical cell of claim 16, wherein the ion-permeable membrane is a multilayer microporous membrane.

19. The electrochemical cell of claim 16, wherein the plurality of projections is defined by a grid, the grid defined by equation n×m, wherein:
n is an integer between defining a number of projections per a cell length, and
m is an integer between defining a number of projections per a cell width.

20. The electrochemical cell of claim 19, wherein n and m are each between about 1 and about 100, and the cell length and cell width are each between about 100 μm and about 5 mm.

21. The electrochemical cell of claim 20, wherein the grid has a grid spacing substantially equal to an average projection width of the plurality of projections, the average projection width no more than about 3 mm.

22. The electrochemical cell of claim 16, wherein each of the second cathode surface profile and the second anode surface profile are defined by a sinusoidal equation.

23. A method of forming an electrochemical cell, the method comprising:
disposing a first electrode material on a first current collector;
positioning a separator on the first electrode material;
impressing the first electrode material to form a first electrode pattern;
casting a second electrode material with the first electrode material to form a second electrode pattern on the second electrode material, the second electrode pattern being complementary to the first electrode pattern; and
applying a second current collector to the second electrode material.

24. The method of claim 23, wherein the first electrode pattern and the second electrode pattern include at least one of a corrugated pattern, a wave pattern, a saw wave pattern, or a sinusoidal pattern.

25. The method of claim 23, further comprising:
impressing the separator positioned on the first electrode material after impressing the first electrode material to cause the separator to have a pattern that matches the first electrode pattern.

26. The method of claim 23, wherein impressing the first electrode material includes impressing the separator positioned on the first electrode material to cause the separator to have a pattern that matches the first electrode pattern.
